(19) United States
(12) Patent Application Publication
(10) Pub. No.: US 2005/0233846 A1
(43) Pub. Date: Oct. 20, 2005

(54) Variable radius continuously variable transmission

(76) Inventors: Arthur G. Green, Nevada City, CA (US); David B. Palley, Nevada City, CA (US); Steven D. Goldsberry, Auburn, CA (US)

Correspondence Address: DAVID PALLEY et al., 103 PROVIDENCE MINE ROAD, #204, Nevada City, CA, 95959, US

(21) Appl. No.: 10/639,147

(22) Filed: Aug. 11, 2003

Related U.S. Application Data
(60) Provisional application No. 60/402,981, filed on Aug. 12, 2002.

(51) Int. Cl. F16H 55/30

(52) U.S. Cl. 474/47

(57) ABSTRACT

An improved variable radius chain or belt transmission is provided for bicycle, motorcycle, automobile, industrial, household and consumer product uses. It delivers power and shifts under power through a continuously variable range of ratios. Alternative means are disclosed: for properly engaging the chain or belt regardless of drive radius; for handing off the workload of the chain or belt even while the drive's effective radius is changing; for minimizing the force required to expand a drive under chain or belt; for supporting the chain or belt attachment points in radially variable manner; for circumferentially bridging the spans between radial attachment points; for coordinating the radial movement of the attachment points within one drive; for actuating up-shifting or down-shifting processes in forward or reverse; and for simultaneously varying the effective radii of input and output drives in coordinated fashion.

### BACKGROUND OF THE INVENTION

1. Field of the Invention

The present invention relates generally to transmissions for use in varying input and output torque and speed ratios, such as are commonly used to transmit motor or pedal generated power to one or more rotating output supports such as drive axles in vehicles, including bicycles, automobiles, trucks, tractors, tanks, motorcycles, pedal boats, all-terrain vehicles and snowmobiles and such as turbines, rotors, drills, blades, knives, mills, winches and presses in industrial machines, generators and household appliances, and the like. It relates more particularly to chain and/or belt transmissions in which the effective radius is variable for at least one sprocket wheel, cogwheel or pulley.

2. Description of Related Art

Transmissions are commonly used to vary transmitted torque and speed in a plurality of ratios between a driver (input) rotating support and a follower (output) rotating support, the two having separate rotational axes spaced from each other. In the most closely related of such transmissions, such rotating supports are located inside an elongate flexible element in the form of a circuit, such as a chain or belt.

### Manual Shift Automobile, Motorcycle, and Bicycle Transmissions

An automobile or motorcycle manual transmission typically involves a number of potentially meshing pairs of gear wheels of discrete differing diameters together with a shifting lever and a clutch to de-power the drive train during shifting. As the driver accelerates in one gear, the engine approaches top speed and exceeds the range at which it performs most efficiently. To make the drive axle turn still faster when the engine cannot, the output-to-input ratio must be increased by an up-shift. To accomplish this the driver eases off the gas, depresses the clutch pedal, and levers a different pair of meshing gears into contact with one another as the engine slows down; he then re-engages the clutch, supplying fuel to bring the engine's speed up again from the below-optimal range into which it has fallen. The automobile or motorcycle decelerates during this shift, and there is abruptness and frictional loss as the clutch re-engages. With such a transmission, engine speed varies widely, power is lost during shifting, clutches and engines wear out, and fuel often is consumed inefficiently. Motorcycles typically use drive chains or belts but with meshing gear transmissions like those of cars, not with bicycle type sprocket clusters and derailleurs. Chains are not customarily used to transmit drive power in automobiles, although recently belts have come to be used in automobile continuously variable transmissions (“CVT's”).

Today's 18 to 27-speed bicycle transmission has evolved in an environment more energy sensitive than that of either motorcycles or cars to comprise a cluster of three sprocket wheels of differing diameters at the pedal crank (“chainring”) and a similar cluster of six to nine sprocket wheels at the rear wheel's axle (“rear cog”), together with a rear derailleur which takes up slack in the chain and which, like a front derailleur also, serves sometimes as a “clutch,” de-powering the chain while lifting it from one sprocket wheel, relocating it onto a neighboring one. The rider shifts gears under changing conditions to optimize output in relation to road slope and the pedaling energy he can muster, given the finite gear choices available. Like the automobile driver, the bicyclist loses a degree of power while shifting (particularly when using the front derailleur) and some efficiency before and after shifting. Sometimes the right gear is non-existent—between or outside the range of existing gears. The conventional bicycle's metal sprocket clusters, derailleur and chain ate heavy, thus they contribute to rider fatigue. They require oil, which attracts abrasive and dirt, in turn entailing mess and need for cleaning bicycle, operator and clothing. Although it is estimated to be 95% efficient, this transmission does not transmit power without loss even in non-shifting mode. The rear derailleur, in taking up slack, requires the chain to travel through two acute bends, and this is a significant source of inefficiency. That the front and rear sprockets selected for use sometimes are laterally displaced causes a lateral tension on the chain and likewise reduces the efficiency of power transfer. Because of such deficiencies and despite a guaranteed slow start, in certain types of track bicycle races winning contestants use one-speed bicycles. Shifting today's multi-speed bicycle requires two levers, two hands, and a degree of complication which can reduce safety, enjoyment, and bicycle use; due to gear ratio overlap and dexterity issues, it is not always done well even with expensive index shifters, particularly by the non-expert. An inexperienced rider can mis-shift so as to laterally bias the chain and even cause it to come off.

A number of variable radius belt transmissions have been proposed in replacement of the sprocket cluster/derailleur bicycle transmission, whose deficiencies are described above. These include six patents by Leonard U.S. Pat. No. 4,030,373 et seq., Williams U.S. Pat. No. 4,342,559 (auto and CVT), Miller U.S. Pat. No. 5,582,555 (auto and CVT). Allard U.S. Pat. No. 6,332,852 critiques the Leonard patents, calling them complex, stating that “the V-belt . . . must usually be heavily tensioned to prevent it from slipping from the pulleys,” and that it nevertheless performs badly in rain. These transmissions involve pulley segments engaging a V-belt. In each shifting entails significant friction at the belt/pulley contacts. None of these bicycle belt transmissions have made commercial headway against chain drive bicycle transmissions.

Numerous variable radius chain transmissions also have been proposed. These include Hufschmid U.S. Pat. No. 4,634,406 (front drive only, notched radial slots and pivotal prongs), Walker U.S. Pat. No. 4,642,070 (front only, sprocket segments spring biased to maximum ratio offset by pedal pressure), Gummeringer, U.S. Pat. No. 4,696,662 (worm gears, front only), Pritchard U.S. Pat. No. 4,787,879 (rear only, drive plate with radial slots and coaxial cam plate with curved slots), Husted U.S. Pat. No. 4,810,235 (spiral-wavy cam, front only), Schendel U.S. Pat. No. 5,476,422 (worm, front only), Allard U.S. Pat. No. 6,332,852 (notched radial slots, front and back). None have achieved commercial success. They tend to be heavy and complicated, as each says about its predecessors. Belt proponent, Williams, U.S. Pat. No. 4,342,559, notes their tendency toward “frequent misengagement of sprocket and chain.” We will here discuss key limitations of the Gummeringer and Schendel patents, which, like the preferred bicycle embodiment of the present invention, use radially threaded rods and internally threaded blocks (“worm gears” and “bores”) to support chain attachment points in radially variable manner.

The fundamental challenge of variable radius chain transmissions is how to alter the radius of the drive or driven sprocket wheel without binding (or bunching up or stretching or breaking) the chain. This is no problem when the chain is attached at one point only, and one tooth, or short segment of teeth, can be strong enough to handle the chain load (just as each link of the chain handles the chain's entire load). However, the chain must always be attached at one point at least or else the chain will slip and become useless, a corollary but fatal problem. Thus the chain also must sometimes attach by at least two points. Schendel and Gummeringer probably solve the slipped/useless chain problem by placing their variable radius transmissions only on the larger of the two drives (so that the chain always contacts at least 180 degrees of circumference). By so doing, they halve shifting range and efficiency, forfeiting the opportunity to employ variable radius shifting simultaneously at both input and output drives. They mitigate the binding chain problem by having only two attachment points, 180 degrees of rotation apart, so that binding occurs for Gummeringer during only two arcs of the drive's revolution, for perhaps 40 to 60 degrees total of the 360 degrees. Gummeringer also calls for “spacing” between teeth and chain to give or take up slack while shifting “during that brief period of time in which both sprocket segments are engaged with the chain at once;” however, to serve this purpose the sprockets would have to fit the chain so poorly that other inefficiencies would arise. Neither invention under discussion provides a good solution for the binding chain problem. Chain and sprocket wear is one negative consequence.

Chain misalignment is a related serious problem of variable radius chain drive transmissions, and a second negative consequence attending failure to solve the binding chain problem. To mitigate chain misalignment and mis-engagement, Gummeringer points out that, with his invention, “It is critical . . . that an exact relationship between the pitch of the threads on the threaded rods be matched to the desired ratio change for each revolution of the unit as well as to the chain link spacing.” Gummeringer's invention would enable one gear change (effectively adding or subtracting two teeth) per single rotation of the drive wheel (and would have to be constrained to stop shifting after perfect single rotation intervals, means for which he does not teach). Schendel designs his transmission to sequentially shift while not under chain pressure just one of several chain “grabber” or “pusher” chain engaging components at a time. Varying one drive only, he calls for eleven different speed ratios in a preferred embodiment. Although he does not say so or teach how, his transmission would mis-align unless the applied spin were precisely calibrated to result in changes of two, four or six links per revolution, and the transmission would have to be constrained always to start shifting when both “grabber” components were chain engaged. Neither invention would permit finer shifting, certainly not continuously variable shifting. Also, it would have to stop shifting after intervals of one perfect revolution (which he does not call for and which would limit shifting flexibility), otherwise these “chain engaging components” inevitably would migrate to differing heights, get out of phase with one another and bollix chain engagement, rendering precise calibration—if any—for naught.

Some of the prior art recognizes that to increase a drive's radius under chain or belt involves overcoming a compressive force which the driving chain or belt itself imposes. It is likely for this reason that Schendel, U.S. Pat. No. 5,476,422, radially shifts his chain “grabber” or “pusher” points one at a time “while they are free from any load being applied thereon by the chain.” This compressive load is ostensibly harnessed, for example, in the “load-responsive variable diameter pulley” of Williams, U.S. Pat. No. 4,342,559, where “in the basic pulley a spring normally urges the movable plate to bias it and belt-engaging segments to the position defining maximum pulley diameter.” Similarly in Miller, U.S. Pat. No. 5,582,555, “resiliently biased slider links between pulley segments . . . are set for the desired input torque resistance. These members allow a drive pulley to collapse in a uniform manner as they are overcome by drive torque as load, transmitted by drive belt tension, increases.”

### “Automatic” Shift Automobile and Bicycle Transmissions

“Automatic” automobile transmissions may use a viscous fluid rather than a hard mechanical connection to transmit torque between rotating disks, much as one electric fan blowing in the face of a second idle fan might cause the latter to rotate. Vehicles so equipped in consequence of this soft connection typically travel several fewer miles per gallon than comparable models with manual transmissions. Neither are such automatic transmissions particularly fuel efficient with respect to engine operating range: one still can hear fuel inefficiency as the engine revs up and down and the transmission proceeds through its series of discreet forward speeds, albeit typically without direct driver intervention. This is not a more efficient automobile transmission, but many favor it for ease of use, smoothness of feel during shifting, and freedom from shifting distraction which may promote safety.

We are aware of no commercially successful or workable “automatic” bicycle transmissions, although patents have been registered which claim such. Williams U.S. Pat. No. 4,342,559 (pulley segments), Walker U.S. Pat. No. 4,642,070 (sprocket segments), Miller U.S. Pat. No. 5,582,555 (sprocket segments) and Warzewski U.S. Pat. No. 5,772,546 (involute-shaped tooth segments) all are spring biased toward highest gear and shift down in response to pedal pressure. This would seem to ensure a slow start and poor shift control finesse. Schendel U.S. Pat. No. 5,476,422, in connection with his distinguishable transmission (which does not work and necessarily includes, for example, guide slots on a guide plate, as the present invention does not), claims an electrically power operated means, responsive to a speed sensor, for automatic control of a shift actuator, similar to that of the present invention.

### Continuously Variable Automobile and Bicycle Transmissions

Continuously variable transmissions (“CVT's”) offer the ease and safety advantages of automatic transmissions generally. In automotive applications they are becoming popular for their smoothness and quiet. Also, and most importantly, even though auto CVT's transmit power inefficiently when measured as an isolated component, they allow the engine to operate within its efficient range and thus produce net fuel economies compared to other automobile transmissions. The prevalent type (on garden tractors, snowmobiles and some Subaru, Nissan, Ford, Honda and Audi cars, for example) uses a metal V-belt to transmit power via friction between two split-half pulleys (or conical equivalents). As the two halves of one pulley are pressed closer together its effective radius increases as the belt is squeezed radially away from its hub; in instant response computer sensors instruct a motor to separate the two halves of the transmission's other pulley so that the V-belt settles into what becomes, effectively, a pulley of smaller diameter. In automotive versions, this CVT typically pushes rather than pulls an extremely complex metal belt, and it outputs only 85-90 percent of the power inputted, a percentage lower even than fluid-drive automatic transmissions. This prevailing auto CVT leaves much room for improvement. In such a transmission much power and efficiency are lost to friction. Both in non-shifting and in shifting modes, belt segments heatedly collide with one another and chafe against pulley walls in processes which are inherently destructive.

In the bicycle prior art, belt-drive CVT transmissions are claimed b y Williams U.S. Pat. No. 4,342,559 and Miller U.S. Pat. No. 5,582,555, among others. As with belt-drive auto CVT's, these transmissions lose power and efficiency to frictional heat especially during the belt-destructive shifting process. Whatever advantages their continuous gear variability may bring seems to be more than offset by the previously described disadvantages of belts as compared to chains and of spring-biased foot-torque shifting, generally. The bicycle (involute-shaped, independently spring-biased tooth segments) transmission of Warzewski U.S. Pat. No. 5,772,546 also might work through a continuously variable range, but it seems unlikely to hold any intermediate gear with an acceptable amount of stability. Its, bias toward highest gear would seem to guarantee a slow start, its springs to guarantee a low degree of shift control. Mills U.S. Pat. Nos. 5,632,702 and 6,354,976 does not set out to vary chain or belt drive radii but instead describes a bicycle CVT internal to the rear wheel hub or bottom bracket shell with a variable eccentric assembly, ratchets, vanes, pawls, and optional planetary multiplier gears. Such a system necessarily involves significant frictional losses when compared to the relatively high efficiency of variable gear direct drive systems.

### OBJECTS

1. An object of this invention is to provide a multi-purpose highly efficient chain or belt drive continuously variable transmission with minimal losses between input and output energy.
2. Another object of this invention is to provide a highly efficient bicycle transmission with minimized frictional losses to transfer pedal power to drive wheel more efficiently than multiple-sprocket/derailleur transmissions even in non-shifting mode.
3. Another object of this invention is to provide a bicycle transmission which transfers pedal power to drive wheel without significant loss of power during shifting, i.e. more efficiently than multiple-sprocket/derailleur and other existing bicycle transmissions.
4. Another object of this invention is to provide a continuously variable bicycle transmission, so that, between designed extremes, the bicycle's operator can select and hold any, or virtually any, given power transfer ratio.
5. Another object of this invention is to provide a bicycle transmission which permits its operator to pedal smoothly and continuously at an optimal rate and workload even while shifting.
6. Another object of this invention is to provide a bicycle transmission which is easy to shift and easy to shift well.
7. Another object of this invention is to provide a bicycle transmission which may be set to shift automatically in response to variation in pedaling speed and/or torque.
8. Another object of this invention is to provide a bicycle transmission which is non-distracting and safe to operate.
9. Another object of this invention is to provide a bicycle transmission which is light-weight.
10. Another object of this invention is to provide a bicycle transmission of low rotating mass.
11. Another object of this invention is to provide a bicycle transmission made of plastic.
12. Another object of this invention is to provide a bicycle transmission which will work with a plastic chain.
13. Another object of this invention is to provide a bicycle transmission which requires little or no oil lubrication and thus tends to remain, and to keep its rider and those who service it, clean of messy oil and dirt associated with oil.
14. Another object of this invention is to provide a bicycle transmission which stays relatively free of dirt and dust contamination, reducing abrasive wear.
15. Another object of this invention is to provide a bicycle transmission not susceptible to rust.
16. Another object of this invention is to provide a bicycle transmission which is relatively quiet in operation.
17. Another object of this invention is to provide a colorful and attractive bicycle transmission.
18. Another object of this invention is to provide a bicycle transmission which may afford power transfer ratios which are exceptionally high and/low compared to conventional alternatives.
19. Another object of this invention is to provide a bicycle transmission which, with its associated tensioning and controls, is relatively inexpensive to manufacture, install and maintain.
20. Another object of this invention is to provide a more efficient automobile variable radius type continuously variable transmission with minimal losses between input and output energy.
21. Another object of this invention is to provide a highly efficient automobile continuously variable transmission with minimized frictional losses in non-shifting mode.
22. Another object of this invention is to provide an automobile continuously variable transmission which transfers power from power source to drive output without significant frictional loss during shifting.
23. Another object of this invention is to provide an automobile continuously variable transmission capable of using a roller chain.
24. Another object of this invention is to provide an automobile continuously variable transmission in which the chain or belt is pulled rather than pushed.
25. Another object of this invention is to provide an automobile continuously variable transmission in which contact between chain or belt on the one hand and sprocket or pulley on the other is non-destructive.
26. Another object of this invention is to provide an automobile transmission which is relatively quiet in operation.
27. Another object of this invention is to provide an automobile transmission which is inexpensive to manufacture, install and maintain.
28. Another object of this invention is to provide a highly efficient motorcycle continuously variable transmission with minimal losses between input and output energy.
29. Another object of this invention is to provide a highly efficient motorcycle continuously variable transmission with minimized frictional losses in non-shifting mode.
30. Another object of this invention is to provide an motorcycle continuously variable transmission which transfers power from power source to drive output without significant frictional loss during shifting.
31. Another object of this invention is to provide an motorcycle continuously variable transmission capable of using a roller chain.
32. Another object of this invention is to provide a continuously variable motorcycle transmission, so that, between designed extremes, the motorcycle's operator (or computer) can select and hold any, or virtually any, given power transfer ratio and/or engine speed and/or engine workload.
33. Another object of this invention is to provide a motorcycle transmission which permits the engine to operate continuously at an optimal rate and workload even while the transmission is shifting.
34. Another object of this invention is to provide a motorcycle transmission which may be manually shifted easily and well.
35. Another object of this invention is to provide a motorcycle transmission which may be set to shift automatically in response to variation in engine speed and/or torque.
36. Another object of this invention is to provide a motorcycle transmission which is lightweight.
37. Another object of this invention is to provide a motorcycle transmission of low rotating mass.
38. Another object of this invention is to provide a motorcycle transmission made of plastic.
39. Another object of this invention is to provide a motorcycle transmission which will work with a plastic chain.
40. Another object of this invention is to provide a motorcycle transmission which requires little or no oil lubrication and thus tends to remain, and to keep its rider and those who service it, clean of messy oil and dirt associated with oil.
41. Another object of this invention is to provide a transmission which allows a motorcycle to have lower center of gravity.
42. Another object of this invention is to provide a motorcycle transmission not susceptible to rust.
43. Another object of this invention is to provide a motorcycle transmission which is relatively quiet in operation.
44. Another object of this invention is to provide a colorful and attractive motorcycle transmission.
45. Another object of this invention is to provide a motorcycle transmission which is inexpensive to manufacture, install and maintain.
46. Another object of this invention is to provide a continuously variable transmission for boats.
47. Another object of this invention is to provide a continuously variable transmission for snowmobiles.
48. Another object of this invention is to provide a continuously variable transmission for industrial applications.
49. Another object of this invention is to provide a continuously variable transmission for household appliances, including quiet, energy efficient refrigerators, air compressors, washers, driers, and the like.
50. Another object of this invention is to provide a continuously variable transmission for generators.

### SUMMARY OF THE INVENTION

The present invention is directed to an improved variable radius chain or belt transmission of a type suited for uses including bicycle, motorcycle, automobile, household, consumer, and industrial applications. More particularly, a variable radius continuously variable transmission is provided which delivers power between at least two rotating supports having separate rotational axes spaced from each other (“usually referred to as “drives” hereinafter) which are located inside and which contact an elongate flexible element in the form of a circuit, often a “chain or belt” such as a roller chain, a segmented or unsegmented cog-belt, or a segmented or unsegmented single or multiple-width V-belt; at least one of said rotating supports has at least one circuit contacting structure (such as a sprocket segment or pulley segment) adapted to contact said circuit and to transmit force between said circuit and said rigid support to which said contacting structure is connected; and that circuit contacting structure is adapted to move in at least two ways: radially relative to said axis of said rotating support, such that a functional diameter of said rotating support is modified; and laterally to “dynamically reposition” itself in a non-radial and non-parallel to axis direction (e.g. tangentially or circumferentially) relative to other portions of said rotating support. This transmission efficiently shifts under power through a continuously variable range of functional drive diameter ratios. Dynamic repositioning facilitates proper engagement of the circuit and circuit contacting structure, and it permits variable radius shifting without the circuit stretching, bunching up or breaking.

To ensure proper engagement of the chain or belt regardless of radius and thus solve the misalignment problem noted, e.g. by Williams, U.S. Pat. No. Reg. 4,342,559, as characteristic of past variable radius chain transmissions, the circuit contacting structure, e.g. sprocket segment, pulley segment, or other chain/belt attaching device (herein usually referred to simply as “sprocket segment”) is mounted to the effective circumference of the drive not rigidly but in a manner, as by placement within a channel upon one or more springs or gears or supported in a slot-topped box within a magnetic field, which allows it to move laterally in a non-radial direction not parallel to the axis (i.e. to “dynamically reposition” itself), typically slightly forward or back, upon cyclical first contact with the sprocket segment before it seats into a position where it may offer at least one-directional resistance to, and so transmit force using, the chain or belt.

This mounting approach means that engagement of the chain or belt does not perilously depend on precise calibration of radial variation, as in Gummeringer, U.S. Pat. No. 4,696,662, and Schendel U.S. Pat. No. 5,476,422, for example. To its advantage, it also permits an expanded number of effective gear ratios, since the distance between adjacent seating positions for a given belt or chain attaching device can be considerably shorter than one chain link. That each sprocket segment (or other force transmitting circuit contacting structure) receives and gives up the chain or belt while not under full load, and, in some embodiments, while unseated, also aids engagement and minimizes wear and friction, increasing efficiency. To further reduce the chance of chain mis-engagement, particularly in embodiments where the sprocket segment or equivalent is spring-hinged and thus meets and departs the chain at an unconventional angle, the sprocket teeth (or counterpart) and chain joints can be pointed or otherwise shaped to facilitate meshing.

The fundamental previously unsolved problem of variable radius chain or cog belt transmissions is how to alter the radius of the drive or driven sprocket wheel without binding or breaking (or stretching or bunching up) the chain or cogbelt. As stated above, this is not a problem when the chain is attached at one point only. However, the chain must never be attached at less than one point and must therefore sometimes attach by at least two points. The present invention solves the binding chain problem by allowing dynamic repositioning of the force transmitting circuit contacting structures, or some of them; these sprocket segments or the like are allowed to move tangentially or circumferentially or otherwise laterally with respect to the drive along the platforms on which they reside.

As discussed below, such lateral repositioning of the circuit contacting structures may take place at several of a platform's drives simultaneously even while under chain, as is necessary if circularity of the drive is to be maintained by insisting that all platforms rise and fall radially as one. Or, if perfect circularity maybe sacrificed, lateral as well as radial repositioning of attachment points can be deferred or restricted to occur only during that arc of the drive when both the point to be repositioned and the platform to be raised or lowered are free of the chain.

Tangential or circumferential dynamic repositioning of the chain attachment points maybe by ratcheting means, generally preferred in bicycle applications, or by non-ratcheting means. Ratcheting permits attachment points to move tangentially only in one direction under chain and to return to a place of beginning only when free of the chain. Non-ratcheting means include motor drive platform-mounted worm gears, which can move the attachment points tangentially in either direction, under chain or free. Other generally simpler non-ratcheting means, such as are employed in the invention's currently preferred automotive embodiment, permit the attachment points to move only free of the chain as needed to initially engage the chain and, following disengagement of the chain, to return to a suitable place of beginning.

The chain always attaches to the effective circumference of each drive at one or more points, often at least two. In those embodiments where all the radial worm gears turn synchronously and the drive's circularity is maintained, during shifting one or more of the attachment points under chain may slip on its platform while at least one other holds firm against chain torque at any given time. In those embodiments where, to avoid fighting compressive forces during radially expanding shifts, only those radial worm gears turn whose associated platforms are then “free” of the chain, some drive circularity is sacrificed but the attachment points, once successfully engaged with the chain, need not ratchet or reposition under chain; all can hold firm against torque chain pressure. A third type of embodiment combines elements of the first two. In these embodiments, repositioning of sprocket segments under chain occurs during radially contracting shifts, with assistance from the chain's compressive force. However, during radially expanding shifts, to avoid fighting compressive forces applied by the chain, radial and tangential repositioning is deferred under chain to occur only in free position.

In ratcheting embodiments, each attachment device on a given drive circumference is mounted in a way that holds and resists slippage in normal “work” direction but that allows slippage in the reverse direction. How this permits input and output drives to expand and contract under power with workload “hand-offs” between adjacent platform-mounted chain or belt attachment devices is described below with reference to FIG. 1.

An additional and substantial benefit of this solution to the binding chain problem is that it permits the transmission between its designed extremes to hold absolutely any radius, and thus it can be said to be continuously variable through an infinite number of gears. In ratcheting embodiments, minor power slippage to a maximum of one ratchet position will occur with negligible frictional loss upon hand-off at certain radii, but other continuously variable transmissions have greater slippage plus frictional losses which are substantially greater.

In non-ratcheting embodiments, power slippage is minimized or avoided.

In the preferred automobile transmission embodiment the attachment points move only free of the chain as needed to initially engage the chain, then seat under chain, and return once again free to a place of beginning. Such a drive is less than perfectly circular during shifting, and its average radius varies on a rolling basis. But if each sprocket segment cleanly engages the chain, power slippage occurs only sometimes and but slightly as the sprocket segment deepens its seating upon transference of the chain's load to the said sprocket segment.

In a more complex, hence less preferred, non-ratcheting auto embodiment, all or some of the attachment devices are movable forward and back on a platform within its channel by means of a platform-based tangentially oriented worm gear. This gear is powered by a small electrical motor; fed data from a sensing device with or without computer direction, the motor turns the worm gear an appropriate amount and direction to ensure proper alignment of, and to protect against stretching or binding, the chain or belt. Useful data for these purposes include: (a) reference platform's own position on radial worm gear; (b) reference sprocket segment's own position on platform worm gear; (c) whether reference sprocket segment is free of the chain; (d) reference platform's “o'clock” position viewed apart from one side; (e) backward (opposite work direction) pressure or motion on sprocket segment; (f) position on radial worm gear of platform ahead; (g) position on platform worm gear of sprocket segment ahead; (h) whether sprocket segment ahead is free of the chain; and (i) position of chain link approaching point of sprocket engagement. Not all these data need be gathered, since, depending on the embodiment, some can be derived from others to allow calculation by a simple algorithm of what platform-based worm gear movement is required for dynamic repositioning to ensure chain engagement and to allow shifting.

In this less preferred circular-type automotive or industrial embodiment, where all of a drive's radial worm gears move in coordination, each sprocket segment is programmed to: (a) hold fast on its stationary platform-based worm gear (with reference to FIG. 1) between, for example, 12:00 and 3:00 on the input drive and between, for example, 9:00 and 12:00 on the output drive as depicted in FIG. 1 (provided that during shifting only one sprocket segment per drive shall hold fast at a time); (b) while free of the chain to reposition itself on its platform relative to the sprocket segment it trails for chain engagement purposes; and (c) elsewhere under chain to reposition correctively in response to radial shifting (i.e. to maintain a constant distance between chain attachment points by moving on its own platform toward the held-fast sprocket segment as the platforms move apart in an expansive shift, and by moving on its platform away from the held-fast sprocket segment as the platforms draw nearer one another in a contracting shift). In another such embodiment, a sensing device registers backward pressure (opposite the direction of work) on a sprocket tooth, instructing a motor to turn the platform worm gear and move the tooth (in work direction) to, then to firmly support it in, a position where such directional pressure eases; when the platform is sensed or surmised to be free of chain, the motor turns the platform-based worm gear to return the tooth along the platform to a point of beginning for next engaging the chain. In another non-ratcheting embodiment, on at least one drive the attachment device in leading position remains fixed while, to maintain constant distance between sprocket segments under chain, a worm gear causes the trailing one or ones to move forward as the drive's radius expands or rearward as the drive's radius contracts. In another embodiment, on at least one drive the attachment device in trailing position remains fixed while, to maintain constant distance between sprocket segments under chain, a worm gear causes the leading one or ones to move rearward as the drive's radius expands or forward as the drive's radius contracts. In another embodiment, neither leading nor trailing attachment devices remain fixed; the worm gear moves them all. In another embodiment, the sensing device itself is mechanical (e.g. a spring). In another, no computer is required because the worm gear is sprung to take up what slack it is given under chain and to give all distance claimed when free of chain pressure. In another, no electrical motor is required because the same motor or human pedal power which powers the drive is leveraged or geared to turn the platform-based tangentially oriented worm gear. In another, no electrical motor is required because the power which turns the worm gear to raise and lower platforms is leveraged or geared to turn the platform-based worm gears.

To minimize the force required to expand a drive under chain or belt, if desired, the present invention offers several methods for deferring its application until the platform to be raised is not under chain (that is to say, until between approximately 7:30 and 10:30 on the input drive and between 1:30 and 4:30 on the output drive as depicted in FIG. 1). If shifting occurs only during a platform's passage through these arcs, some drive circularity is sacrificed because, during shifting, the platforms at times will be at different heights. (Means to restore circularity include springs and laser-guided motor-driven worm gears.) These embodiments which lose circularity in expanding shift mode may or may not do so in radially contracting shift mode; a choice is offered because contracting shifts do not oppose the chain's compressive force. Thus in some embodiments circularity is the ruling value and the platforms are designed to lower in concert with one another, while in others simplicity prevails, and both expanding and contracting shifts are constricted to occur during the same arcs of the drive.

In a preferred automotive and industrial CVT embodiment (imperfectly circular during both expansive and contracting shifts), the radial worm gears which raise or lower the platforms and the platform-mounted smaller worm gears which dynamically reposition sprocket segments on platforms turn only while free of the chain. Torsion springs mediating between associated worm gears and pinion gears in this embodiment should be capable of turning in either direction from a resting position and gauged to release imparted forces and turn the worm gears (raising or lowering the platform) only in free position. If mechanical advantage can not be made sufficient to overcome the chain's compressive force, a locking device should prevent the worm gears from turning at all times when they are not in free position.

In another, perhaps less practical, industrial or automotive embodiment, the radial worm gears to raise the platforms only turn when free of the chain, but all radial worm gears turn together to lower the platforms; and the sprocket-repositioning platform-mounted smaller worm gears are not so limited: they reposition as necessary to engage the chain (as sprockets come off free position) and to adapt to radial shifting in general, but one of them at a time holds fast between, for example, approximately 12:00 and 3:00 on the powered drive and between 9:00 and 12:00 on the driven drive as depicted in FIG. 1.

In a preferred bicycle embodiment deferential to compressive chain force, the radial worm gears and the pinion gears at their base are joined by a coil spring and are not rigidly attached to one another. See FIG. 5 and the associated text. Thus the pinion gears, connected as they are to a common transfer (or bevel) gear, will turn in concert. But because it would take an estimated 40% of the operator's applied pedaling power just to overcome compressive chain force and to power such an expansive shift, the spring is designed to not lift a platform while it is under chain. Instead when the pinion gear rotates the spring coils and stores energy in an amount which does not tax the operator but which is sufficient to lift the platform when it uncoils upon the platform's release by the chain a short while later when the platform rotates into “free” position. (Those platforms initially in free position will already have been lifted.) The coil spring is so designed and so positioned and is strong enough that it neither coils nor uncoils and the pinion gear and worm gear turn as if rigidly joined during a contracting shift and during non-shifting operation. In embodiments where the radial worm gears are interconnected also at their outer extremities (for example, by spur gears and spur gear racks), then similar coil springs also would mediate the delivery of torque between such worm gears and their associated spur gears.

In another simpler bicycle embodiment (with drives which would be less circular during a contracting shift), no transfer gear coordinates the raising and lowering of the worm-gear mounted platforms; the platforms shift only in that position where they are free of the chain, actuated by a device there located which turns only the worm gears of platforms there then; means described elsewhere herein such as spring-hinges (or magnets) and variable seating positions assist each sprocket segment coming from free position to successfully engage the chain at a proper interval behind the loaded sprocket in front of it; that interval remains constant while the two platforms in question both bear the chain, as platforms rise or descend only free of the chain; thus, once engaged and until free again, no ratcheting would be required during any shift.

In its preferred embodiment, the present invention uses radially threaded rods and internally threaded blocks (worm gears and bores) to support the chain attachment points in radially variable manner, somewhat in the manner of Gummeringer and Schendel, with means also to prevent platform rotation. Each attachment device is borne on a stable platform so as to allow its dynamic repositioning thereon. In one embodiment, each platform has bores to carry and is supported by two worm gears, one to the left and one to the right of the chain's path; each platform also has multiple column guides each of which embraces a non-threaded column to permit sliding but prevent twisting and dipping of the platform. In another lighter but somewhat less sturdy embodiment, each platform is supported by one or more worm gears and associated non-threaded columns per platform to only one side of the chain. A simpler third, and now preferred, embodiment employs one worm gear only to one side of the chain but one or more non-threaded support columns in addition, preferably at least one to the side of the chain opposite the worm gear. Columns and column guides are not the only means to prevent the platforms from twisting and dipping; alternatives include worm gears and bores, face plates or other structural members with guides to engage platform slots, face plates or other structural members with slots to slidingly engage platform tabs or guides.

To bridge the spans between radially mounted attachment points and maintain an approximately circular shape to each variable diameter segmented sprocket wheel, a preferred embodiment of the invention uses cantilevered support arms. Another embodiment uses overlapping coiled leaf springs to bridge these spans. A third embodiment uses additional worm gears supporting miniature free-wheeling sprockets, empty channels, or other means which support the chain but allow it to slip. A fourth embodiment has chain-engaging platforms exclusively but in relatively greater number.

In the now preferred bicycle embodiment, coordination between platforms is coordinated at the bottom alone, by a hub-mounted beveled transfer gear which mates with a beveled pinion gear at the radially inner end of each worm gear. To coordinate the radial movement of the platforms and attachment points within one drive a sturdy embodiment of the invention (also depicted) uses both a spur gear rack which mates with a spur gear at the outer end of each worm gear and a hub-mounted beveled transfer gear which mates with a beveled pinion gear at the radially inner end of each worm gear. In another embodiment, coordination might be only by gearing at the top of each worm gear.

In those embodiments where worm gears are used both to the left and to the right side of each platform, gearing, such as pinion and hub-mounted beveled transfer gears, may be used to coordinate their turning with respect to one another. In the preferred automotive embodiment, the gearing to coordinate the two worm gears of a single platform is located at the extended bottoms of the worm gears within the hub.

To turn a worm gear and change the effective radius of one drive of the invented transmission, various means are offered. Toward the top and bottom ends of the worm gear are the best places to apply rotation to them. At the bottom end within the hub is particularly advantageous to enable a particularly small effective drive radius and thus to extend the range of available gear ratios. A spur or pinion gear fixedly turning with the worm gear offers a good means for applying such rotation, particularly when it or a bevel gear to which it engages is mounted to a shifting disk or other actuating device which normally rotates with the drive hub and at the same rate of revolution when no shifting takes place. A motor could be used to rotate one or more worm gears. With respect to those embodiments which include one or more shifting disks, shifting is initiated when one slows, stops, or speeds the rotation of one shifting disk relative to its associated drive crank or driven sprocket hub. (This is similar to Gummeringer using actuator arms to stop actuator disks, although the present invention does not require a hard stop as his does.) For faster shifting, the shifting disk of the sturdy embodiment of this invention carries a spur gear rack directly mating a spur gear atop each worm gear. For slower shifting, the shifting disk might mate a pinion gear near the bottom of each worm gear. Shifting will be faster when braking is applied to the faster rotating drive, generally the output drive on a bicycle (in most of its gears), the input drive on an automobile.

To actuate shifting, a preferred bicycle embodiment utilizes a tall shifting disk and an angled shifting disk, mediated by a circumference gear with a sun and several planetary gears. Caliper or other friction-type braking is initiated as by the operator using a handlebar control; that force is transmitted by cable, and is applied to one or the other shifting disk so as to cause rotation of the worm gears in either an expanding or a contracting shift direction.

In another bicycle embodiment, a shifting lever arm pivots from a point on the bicycle frame; toward one end is a cable housing and a cable which maybe operated from the bicycle's handlebar to push or pull that end of the shifting arm; the opposite end, beyond the pivot point, terminates near so as sometimes to contact the shifting disks of the transmission device. This contacting end is forked and each fork holds two rubber-tired ratchet wheels on a axle paired to freewheel in opposite directions. Springs return the shift arm to center when the transmission is neither up-shifting nor down-shifting, and in this position no ratchet wheels contact either shifting disk. When one pulls the shift arm cable while pedaling in a forward direction, each in a pair of ratchet wheels on a single axle contacts a different shifting disk of the device; one wheel brakes a shifting disk (causing movement of the worm gear, thus either up-shifting or down-shifting), and the other freewheels. Braking can be hard and definitive or soft and slipping. When one pushes the shift arm cable while pedaling forward, the other two wheels on their single axle contact the same shifting disks, one each; one wheel brakes the shifting disk which did not brake before, and the other freewheels. If one pedals backwards (to shift rapidly, e.g.), shifting occurs in like manner, without control reversal, but using opposite ratchet wheels. A similar embodiment with fewer and simpler “shift brakes” also will permit shifting while reverse pedaling if one tolerates control reversal. In other embodiments, such as in an automobile transmission, a motor can be used in gear or frictional connection to slow, speed, or stop either or both shifting disks (or actuators) at one or both drives of the transmission.

The variable radius transmission of the present invention could be positioned only on the driver or only on the follower rotating support. However, in a preferred embodiment for improved speed and range of shifting, a pair of these variable radius drives function cooperatively with one another, one radius contracting as the other expands. For many applications a computer may function with measuring and control devices to accomplish this. For others, slack or tension in the chain or belt created by the shift in one independently shifted drive's radius may mechanically signal and initiate an inverse, and thus dependently shifted, change in the radius of the other. In a preferred bicycle embodiment, a frame mounted chain-tensioning arm, bent at the elbow, is sprung so that its chain-carrying hand, when able, will take up loose chain and return to a neutral position: when the operator causes one drive to expand or contract this alters chain tension, forces the tension arm's chain-carrying forearm up or down, and rotates above the bent elbow the upper arm's laterally disposed cam or cylinder shaft, which in turn winds up one encircling cable and unwinds another; and these cables operate calipers, one affecting an up-shift actuator, the other a down-shift actuator on the second drive. In a variant embodiment for the sturdy bicycle embodiment, a shifting arm (slotted top to bottom so that the chain may travel through it) pivots from a point on the bicycle frame; toward one end is a tension freewheel which yields to vertical pressure when, as a result of expansion of drive one, the chain tightens; counteracting this vertical pressure is a spring from the frame to the shifting arm, so that the shifting arm stays in a neutral position when chain tension is moderate, but moves one way (for example, down) when the chain is tight and the other way (up) when the chain is loose; on the opposite end of the shifting arm is an actuator device positioned, when pivoted by the shifting arm, to initiate inverse shifting of drive two, as by impeding one of its shifting disks from rotating together with its associated drive (crank or rear wheel). In non-bicycle embodiments, the first drive might be actuated not by an operator but by a computer or according to an algorithm which, for example, assumed a preference for starting in low gear and progressing to a high gear.

The transmission of the present invention in some applications may be made of light-weight plastic and used with a light-weight, self-lubricating (and thus non-messy) plastic or metal and plastic chain, such as is disclosed in Green and Palley, U.S. Pat. No. 5,520,585 and U.S. Pat. No. 5,728,023. This should reduce costs in mass production. Also it is advantageous in certain bicycle applications. (A plastic chain of conventional dimension is not strong enough for bicycle applications. If such chain is bulked up to have the necessary strength for at least some bicycle applications, its bulk will limit the number of gears available by means of a sprocket cluster and derailleur type transmission but, however, will impose no such limitation in connection with the present continuously variable transmission.)

The transmission of the present invention may be shifted easily, for example, with one hand or thumb using a single manual lever, one direction for up, the other for down, neutral to maintain the present gear ratio (or, as a different example, with left thumb to up-shift, right thumb to down-shift). Alternatively, the transmission can, at the operator's option, be automatically shifted based on measured operating parameters. In a preferred “automatic” bicycle embodiment, the operator may set the transmission to maintain a certain stroke speed (number of crank revolutions per minute), so that down-shifting automatically occurs (or the operator is audibly or visually signaled to down-shift) if a sensor detects that he pedals too slowly and up-shifting occurs if he is detected to pedal too rapidly. Like the driver of a car with “cruise control,” the bicycle operator with such an automatic “stroke cruise” feature can easily adjust his stroke speed setting up or down, or he can shut it off in favor of manual shifting. In other embodiments, shifting may automatically occur or be signaled in response to wattage output or variations in torque delivered to the crank pedals or signals from the operator's bicycle computer or heart rate monitor or the like.

### BRIEF DESCRIPTION OF THE DRAWINGS

FIG. 1 presents a schematic side view of a bicycle's input and output drives with the transmission in a preferred embodiment to illustrate how a ratcheting version of the invention's dynamic repositioning accommodates radial variation of input and output drives during up-shifting and down-shifting.

FIG. 2 generally illustrates a perspective view of a preferred embodiment of a single variable radius drive, as might be located on either a drive shaft (“chainring”)or a driven shaft (“rear cog”) of a bicycle or motor. Platforms are shown positioned at an intermediate position. A chain is shown also.

FIG. 3 generally illustrates a partially cut-away view of a slightly different perspective of the same FIG. 1 preferred embodiment of a single variable radius drive, also with platforms shown positioned at an intermediate position.

FIG. 4 generally illustrates an exploded perspective view of the FIG. 1 preferred embodiment of a single variable radius drive.

FIG. 5 generally illustrates a cross-sectional end view of a preferred embodiment of a single variable radius drive, corresponding to FIGS. 2 and 3 with platforms at an intermediate position. The platform's chain-carrying channel is shown centered between two support rings, beyond and outside of each of which is a shifting disk. Detail B shows the spur gear at the stepped down outer extremity of one worm gear and its mating with a spur gear rack residing on a corresponding shifting disk. Detail C shows a pinion gear toward the radially inner extremity on each of a pair of worm gears and their communication with one another via a pair of transfer gears rigidly attached to the transmission support hub.

FIG. 6 generally illustrates a perspective view from above of a platform of the invention in a preferred bicycle embodiment including an upper ratchet rack with sprocket segment sprung up in unloaded position. The near sidewall of the platform base is missing to reveal details.

FIG. 7 generally illustrates an exploded perspective view from of a platform of the invention in a preferred bicycle embodiment including an upper ratchet rack.

FIG. 8 generally illustrates a perspective view from above of a platform base constructed on a radius including lower ratchet rack of the invention in a bicycle embodiment.

FIG. 9 generally illustrates a perspective diagrammatic view of a bicycle chainring and rear cog of the invention with chain, independent shift actuating mechanism, tensioning free wheel, and dependent shift actuating mechanism in a preferred embodiment.

[FIGS. 11-17 depict an embodiment “sturdier” than that depicted in FIGS. 1-10.]

FIG. 11 generally illustrates an isometric view of a sturdy embodiment of a single variable radius drive, as might be located on either an input drive (“chainring”)or an output drive (“rear cog”) of a bicycle or motor. Platforms are shown positioned at an intermediate position. A chain is shown also.

FIG. 12 generally illustrates a partially cut-away isometric view (from a slightly different angle) of the same FIG. 11 sturdy embodiment of a single variable radius drive, also with platforms shown positioned at an intermediate position.

FIG. 13 generally illustrates an exploded perspective view of the FIG. 11 sturdy embodiment of a single variable radius drive.

FIG. 14 generally illustrates a cross-sectional end view of a preferred embodiment of a single variable radius drive, corresponding to FIGS. 11 and 12 with platforms at an intermediate position. The platform's chain-carrying channel is shown centered between two support rings, beyond and outside of each of which is a shifting disk. Detail B shows the spur gear at the stepped down outer extremity of one worm gear and its mating with a spur gear rack residing on a corresponding shifting disk. Detail C shows a pinion gear toward the radially inner extremity on each of a pair of worm gears and their communication with one another via a pair of transfer gears rigidly attached to the transmission support hub.

FIG. 15 generally illustrates a perspective view from above of a platform of the invention in a sturdy bicycle embodiment including an upper ratchet rack with sprocket segment sprung up in unloaded position. The near sidewall of the platform base is missing to reveal details.

FIG. 16 generally illustrates an exploded perspective view from of a platform of the invention in a sturdy bicycle embodiment including an upper ratchet rack.

FIG. 17 generally illustrates a perspective view from above of a platform base constructed to approximate a circumference including lower ratchet rack of the invention in a bicycle embodiment.

### DETAILED DESCRIPTION OF THE PREFERRED EMBODIMENTS

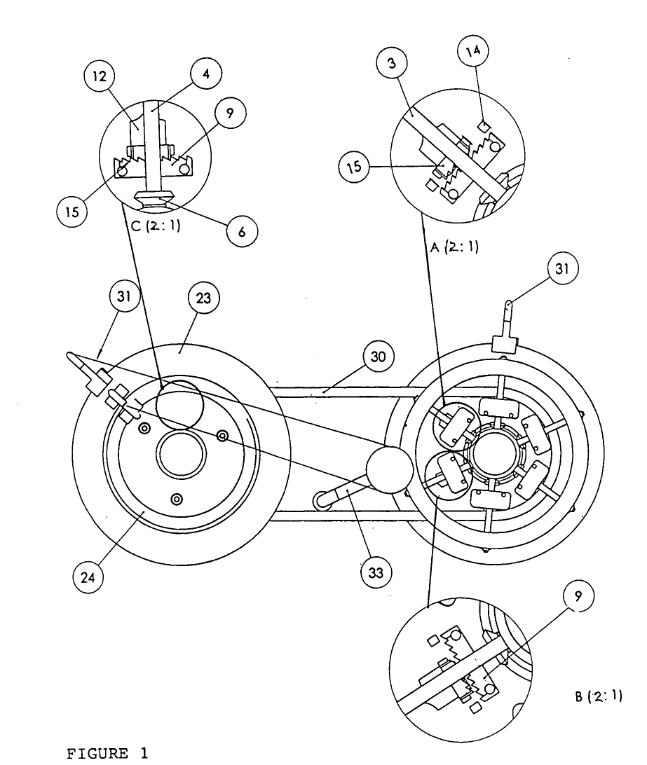

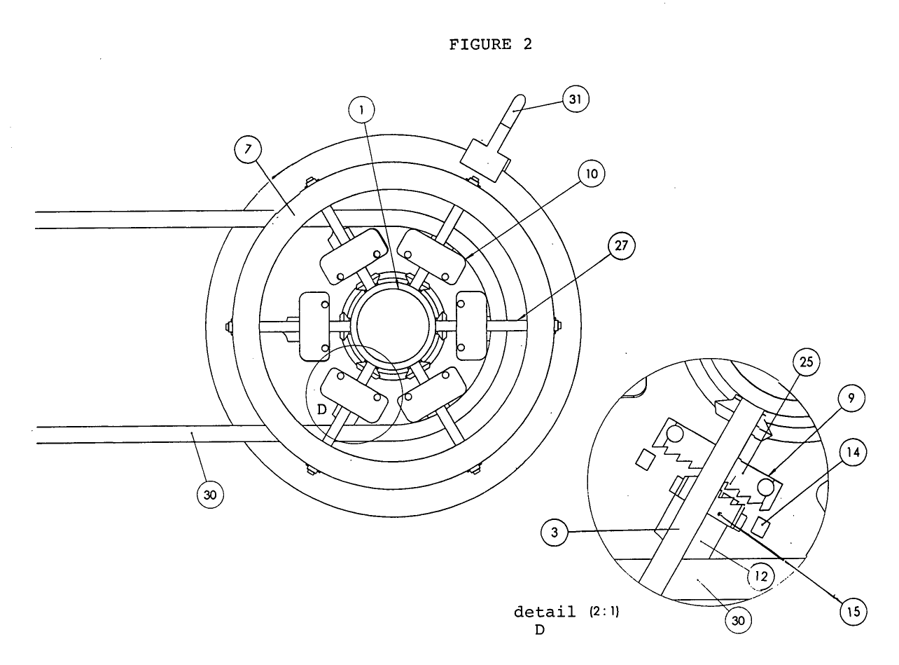

FIG. 1 presents a schematic side view of two drives of the continuously variable transmission in a preferred embodiment together with a circuit in form of a chain 30, depicting a bicycle set to move from left to right as viewed, with the transmission in a preferred embodiment. A pedal 34 shown on the drive at the right of the figure indicates that it is the input drive, or driver; the drive to the left of the view is the follower. The two drives are identical but we view their opposite sides. (Shifting disks are not shown on the driver in this view).

Each drive in this embodiment includes six platform bodies 10 which form a rotating support. The diameter of the rotating support is continuously variable within a range, as each platform is fitted with a threaded bore (26—better shown in other figures) so that its position may be radially varied by the rotation of a radially oriented worm gear 4. Opposite the worm gear and bore a support rod 3 penetrates a support rod guide 27 of the platform body to prevent the platform from spinning with the worm gear's rotation and to ensure that it instead responds by moving radially. A drive's hub 1 and its platform bodies 10 rotate together; with respect to the hub, each platform is capable of moving only radially. Within each platform body is a sprocket module 11 capable of movement not only radially with the platform body but also laterally with respect to it, i.e. up-ratchet or down-ratchet in a tangential direction.

A circuit contacting structure in the form of a sprocket 12 emerges from a slot 28 in the roof of each platform body 10. It is part of a sprocket module 11. The six sprockets of each drive as depicted form a segmented sprocket wheel (to which circularity is added by the upper front and rear ends of each platform body) such that rotational force can be transmitted from one drive to the other via the circuit, here a chain 30.

Within each platform body 10 is at least one sprocket 12 fitted to an upper ratchet rack 15; the floor 9 of each platform body comprises a corresponding lower ratchet rack 25. (See FIG. 8 for an exploded view of a platform body.) When under pressure of the chain 30, the racks 15 and 25 engage one another so that the sprocket segment 12 offers resistance to the chain 30 in one (work) direction only but travels with relative freedom in the opposite direction. When the ratchet racks are not pressed together by the chain, centrifugal and magnetic forces cause them to separate; the sprocket segment with attached upper rack then disengages and re-positions itself, up-ratchet, at a suitable position for re-engaging the chain.

Each pair of ratchet racks on the input drive (to the right of FIG. 1) is oriented in the same work direction as the Detail A and B pairs, and thus, when pressed together under chain (as is the case depicted at the 1:00, 3:00 and 5:00 positions) they will offer resistance to the chain and transmit power when the drive is pedaled or otherwise made to rotate forward over the top, in what is here shown as clockwise direction. (The upper ratchet rack on this input drive cannot release counterclockwise with respect to its lower counterpart; but it could release clockwise if need be.)

Detail A shows ratchet racks 15 and 25 poised to engage; chain 30 and sprocket 12 are not yet in contact with one another. Opposing magnets 14 of like pole lift and separate the upper ratchet rack 15 from the lower ratchet rack 25; the slotted ceiling of the platform body 10 keeps the sprocket module 11 from separating too far from the platform floor 9. Different other opposing magnets 14 of like pole at the front and rear ends of each upper ratchet rack 15 and in the interior front and rear ends of the platform bodies 10 keep the sprocket module 11, when free of the chain, at an intermediate position neither too forward nor back. As the input drive is pedaled forward, first the “floating” sprocket 12 meets the chain 30 and is pushed into alignment with respect to its links, then the sprocket module's (upper) ratchet rack 15 is pressed down to engage the platform floor's corresponding (lower) ratchet rack 25. Detail B shows ratchet racks 15 and 25 disengaging; the chain 30 has begun to leave the sprocket 12, and magnets 14 will separate the racks and re-center the sprocket module within the platform body in readiness for cyclical re-engagement.

On the output drive (to the left of FIG. 1) the same mechanisms as on the input drive facilitate alignment of chain and sprocket and seating of the ratchet racks. However, the ratchet racks on the output drive, as shown in Detail C, to perform work as required, are oriented in the opposite direction. As the chain is pulled clockwise over the top of the follower, or output, drive, the ratchets resist; the follower drive's sprockets cannot release clockwise while the chain presses upper and lower ratchet racks together. (But they can release counter-clockwise if need be.)

In contracting shift mode, the platforms of a given drive move closer to one another. In expanding shift mode, they move apart from one another. But the chain need not bunch up or bind in either event if some of the chain-carrying sprockets, while under the chain's pressure, are able to slip forward or back on the platforms to maintain such constancy of distance between sprocket segments as the chain requires. Non-radial dynamic repositioning of sprocket relative to platform is what permits shifting to occur in this invention without the chain stretching or binding, by ratcheting means in this embodiment.

To illustrate with respect to FIG. 1 how dynamic repositioning by ratcheting permits shifting, let us take, for example, a down-shift, in which the right hand input drive's effective radius contracts and the left hand follower's effective radius expands. To discuss first the contracting input drive, its platforms during this process will get closer to one another; however, if the chain is not to bunch up or bind, the sprockets on any two platforms under chain must make a compensating counter-move to maintain a constant distance between them while both are under load of an inelastic chain. As stated in italics above relative to FIG. 1, the input drive's sprockets do not release counter-clockwise under contact of the chain, but they will release clockwise if need be. If the trailing sprocket (shown, in clock terms, at 12:00) were to release in the only direction it can, it would get closer to the sprockets leading it (at 2:00 and 4:00), compounding the closeness fostered by radial contraction of the drive. This would likely bind the chain. But the sprockets at 2:00 and at 4:00 even while in contact with the chain can maintain a more constant distance in their separation if instead they release clockwise (in the only direction they can). So this is what happens; at the input drive, the leading sprockets release and the trailing segment carries the load during a (contracting) down shift. A “hand-off” of the chain's workload occurs from one platform and sprocket segment to another as each trailer rotates and is succeeded in turn by the formerly free sprocket segment next trailing it.

During the same down-shift, the output drive's effective radius expands. In expanding mode, its platforms will get farther from one another, but there will be problems if its chain-loaded sprockets are unable to maintain a more constant distance by making compensating moves toward one another. As stated above, the output drive's sprockets as shown in this Figure do not release clockwise while in contact with the chain but only counter-clockwise. To offset the increasing distance between platforms, the leading sprockets shown at 12:00 and (not shown, but ratchets would face the same way) 10:00 must move relatively toward the trailing one at 6:00. If the trailing sprocket at 6:00 were to release counter-clockwise in the only direction it can, it would distance itself from the leading ones under load, compounding rather than offsetting the distancing caused by the drive's expanding radius. But the leading sprockets in contact with chain can maintain a more constant distance between themselves despite radial expansion of the drive if they release counter-clockwise (in the only direction they can). So they do. At the rear cog (i.e. output drive) the trailing sprocket segment carries the load during an (expanding) down-shift. A load “hand-off” occurs from one platform and sprocket segment to another as each trailer rotates and is succeeded in turn by the formerly free sprocket segment next trailing it.

To summarize the foregoing, during a down-shift, both at the input and at the output drive, the workload of the chain is carried by the trailing sprocket and platform. Dynamic repositioning occurs on the leading platforms under chain.

During an up-shift, the input drive's effective radius expands and the output drive's effective radius contracts. The invention permits this in similar fashion, with up-shift ratcheting occurring in the only direction possible. But, in an up-shift, both at the input and output drive, it is the trailing sprockets which release. In up-shift mode, it is the leading sprockets which hold firm and carry the chain's workload until each leader by rotating comes free from the chain and is succeeded in turn as leader by the one next trailing it.

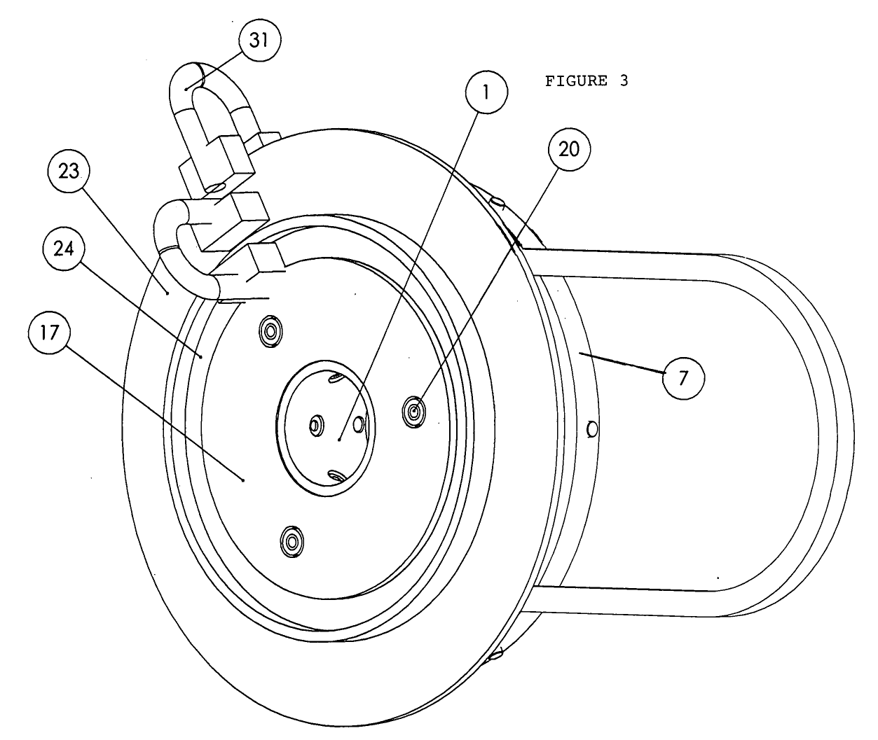

FIG. 2 generally illustrates a side view of a preferred embodiment of one variable radius drive. This view corresponds to the right-hand driver of FIG. 1. The support rods 3 and the support rod circumferential ring 7 are to the foreground in front of the chain 30, blocking view of the worm gears and worm gear support ring; parts of the pinion gears 6 and of the bevel gear 21 are visible to the rear, as is the outer portion of the tall shifting disk 23, with caliper 31. Platform bodies 10 are shown positioned at a low-intermediate position. Sprockets 12 emerge from within each platform and are visible in this view, particularly those on the platforms which are free of the chain (here shown at 7:00, 9:00 and 11:00). Detail D shows the chain 30 coming free from a sprocket 12, as like-pole facing magnets 14 sunk into the ratchet racks separate upper ratchet rack 15 from lower ratchet rack 25 and other magnets 14 located at front and rear of the sprocket module 11 (of which the sprocket and upper rack are part) center it between the magnets at the front and back interior of the slotted hollow platform body 10. An exploded view of this embodiment's platform and its components is shown at FIG. 8.

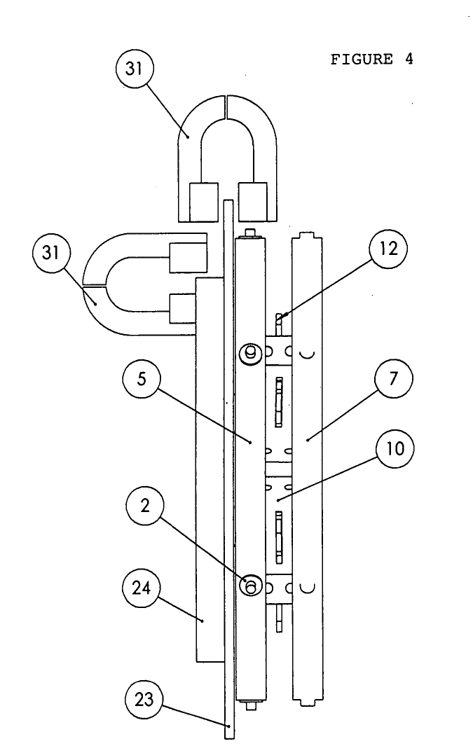

FIG. 3 generally illustrates an isometric view of a preferred embodiment of one variable radius drive. It corresponds isometrically to the left-hand follower drive of FIG. 1. Tall shifting disk 23 and angled shifting disk 24 are shown with calipers 31 to the foreground in this view. Platforms are positioned at a low-intermediate position but blocked from view. A drive belt or chain 30 rides the sprockets entering and exiting the drive between the support rod circumferential ring 7 (more distant) and the (nearer but here blocked from view) worm gear support ring 7.

Rigidly attached to the hub 1, so as invariably to rotate with it exactly, is a gear plate 17 which houses three planetary gear bearings 20. We will call “the hub assembly” this combination of the gear plate (with planet gear bearings) and the hub. This hub assembly rotates with the hub.

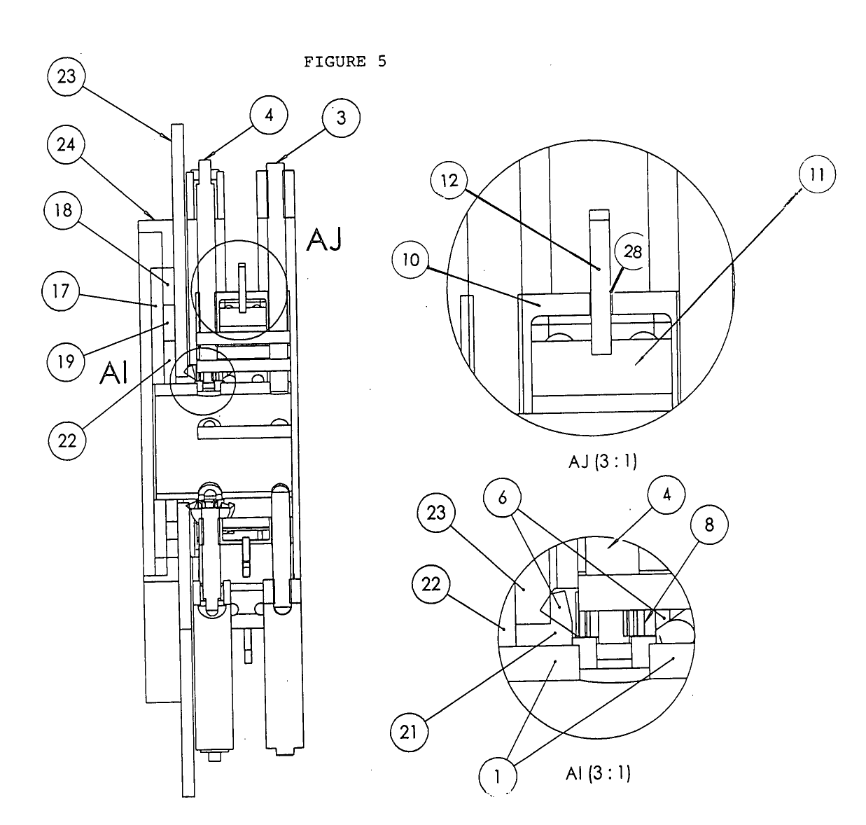

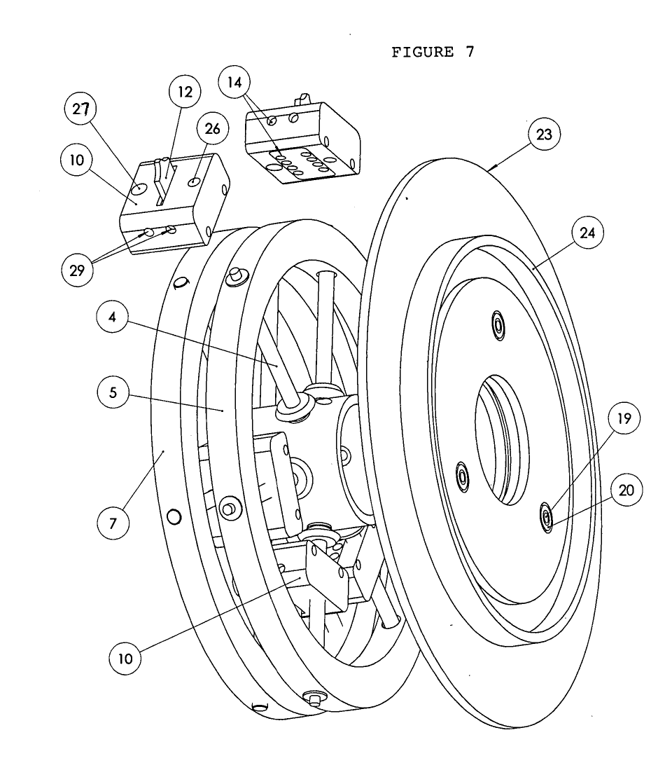

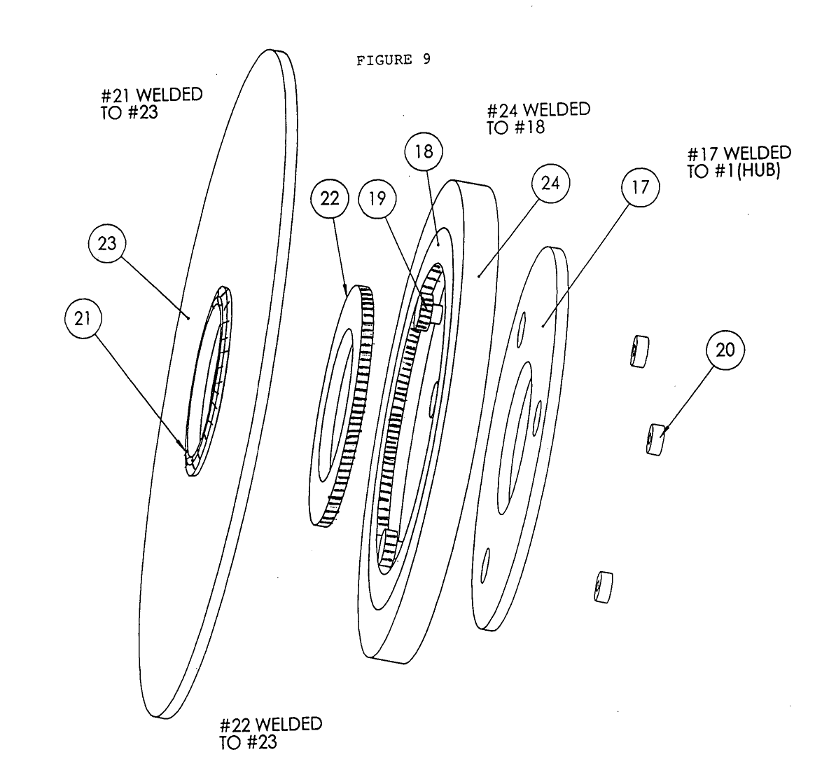

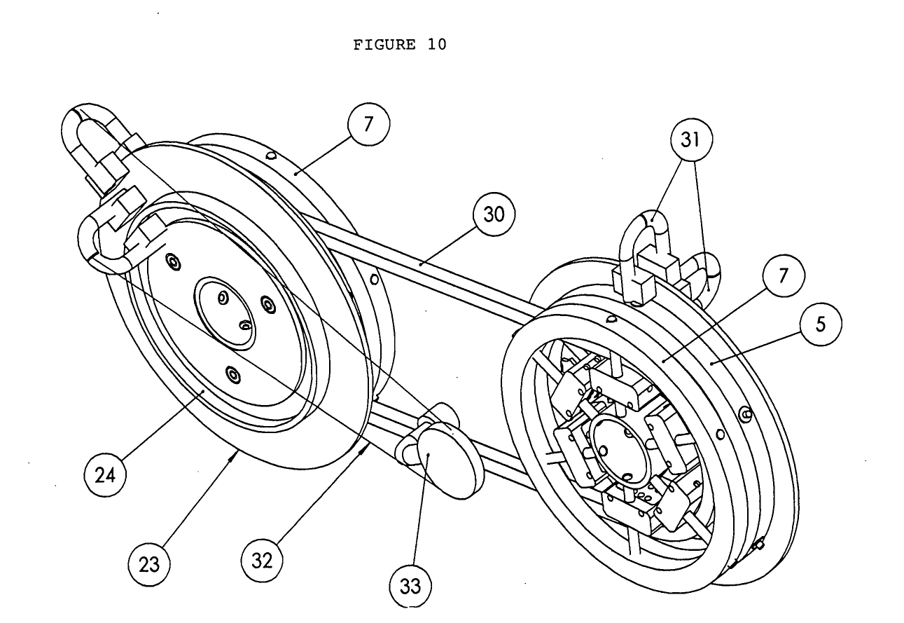

FIG. 4 generally illustrates an end view of a preferred bicycle embodiment of the variable radius drive. Tall shifting disk 23 and angled shifting disk 24 are shown with calipers 31 to the left in this view. A support rod circumferential ring 7 is shown to the right. To its immediate left are the platform bodies 10, positioned at a low-intermediate position. Sprockets 12 are visible in or protruding from slots 28 in the roofs of the platform bodies. Next moving left is the worm gear support ring 5, distinguishable by worm gear bearings 2 to reduce friction and facilitate rotation of the worm gears (here blocked from view). Rigidly attached to the hub 1 is a gear plate 17 which houses three planetary gear bearings 20. When the sideways facing caliper 31 stops or slows the angled shifting disk 23 relative to rotating hub 1, the circumference gear 18 (not in this view) attached to it likewise stops or slows, and planetary gears (blocked from view) are set in motion causing accelerated reverse motion of the sun gear 22, the bevel gear 21 and the tall shifting disk 21. Continuing rotation of the hub 1 in one direction while the bevel gear moves in accelerated fashion with respect to it, causes rotation of the pinion gears and worm gears in the opposite direction (as would be effected if the tall angled disk had been braked). The reverse rotating worm gears vary the radial height of the platforms in opposite fashion, thus the effective diameter of the drive. See FIG. 9 for an exploded view of the shifting disks and associated gearing. See FIG. 6 for a cutaway view of a drive including bevel, pinion and worm gears.

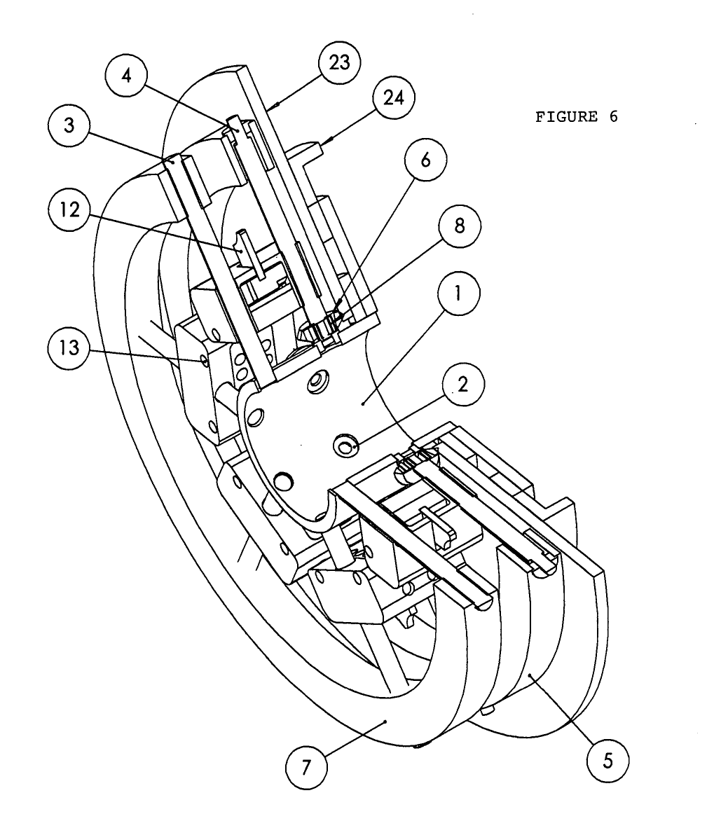

FIG. 5 generally illustrates a cross-section of FIG. 4 (at the half-way back point) with two details.

Detail AJ illustrates a sprocket module 11 within a platform body 10. A sprocket 12 comprises the uppermost part of the sprocket module, and may be seen emerging from the platform body 10 through a slot 28 in the roof of the platform body.

Detail AI illustrates how the angled bevel gear 21 and the angled pinion gear 6 engage one another and convert axial rotation of the bevel about the hub 1 into a twisting rotation of the radially oriented worm gear 4. The tall shifting disk 23 is welded or otherwise rigidly affixed to the stem of the bevel gear 21, forming part of what we shall call the tall shifting disk assembly. But the hub 1 and the bevel gear 21 are not joined; the bevel gear 21 may slide around the hub 1 but it must pass and turn pinion gears 6 to do so.

Detail AI also shows a torsion spring 8, found in this but not all embodiments of the continuously variable transmission. It is located near the base of each worm gear 4 at a thinned part thereof, near where the worm gear enters a worm gear bearing 2. It coils around the worm gear 4; one of the spring's ends attaches rigidly to the worm gear 4 and its other end attaches rigidly to the pinion gear 6. A torsion spring 8 of lesser or greater resistance can be used, depending on whether one wants the worm gear 4 never to turn except when its associated sprocket 12 is free of the chain or instead to turn during contracting but not during expansive shifts. In this preferred bicycle embodiment, the spring 8 is stiff enough to not coil during a contracting shift but sufficiently giving that it will coil and store energy during an expansive shift. It is desirable that the spring not lift a platform 10 under chain during an expansive shift because to do so would take undue amounts of operator energy better applied to moving the bicycle forward. Instead during an expansive shift when the pinion gears 6 rotate, if the sprocket in question is then being pressed by the chain, the torsion spring 8 will coil and store energy for release shortly thereafter. When the associated platform and sprocket come free of the chain, the spring uncoils and the free platform lifts in the amount of the stored increment with relative ease.

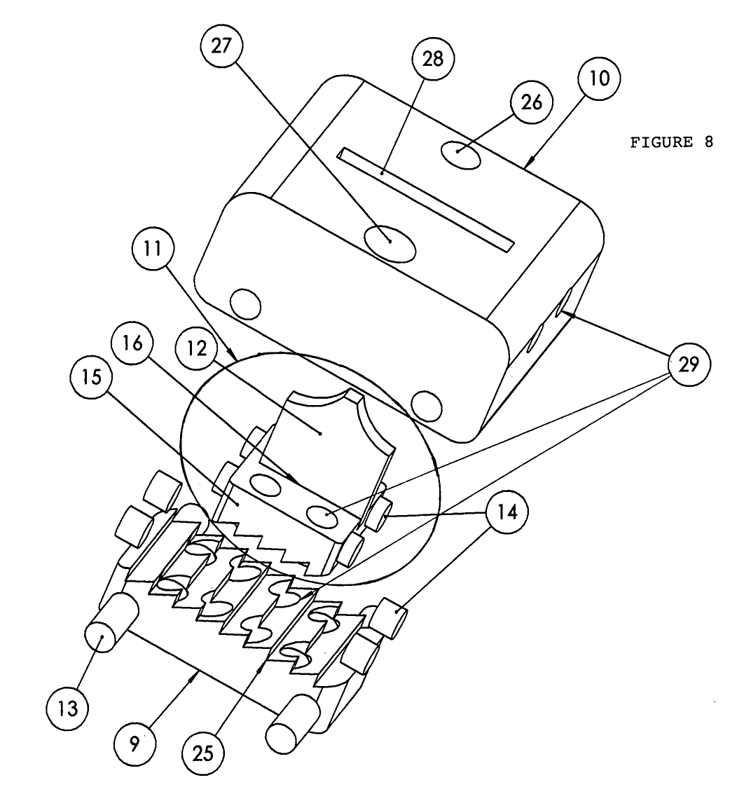

FIG. 6 generally illustrates a partially cut-away isometric view of a preferred bicycle embodiment of one variable radius drive of the invention. This view compares isometrically to the right-hand driver of FIG. 1. The support ring 7 and support rods 3 appear to the foreground in this view. Shifting disks 23 and 24 are to the rear. We will reserve discussion of how shifting is actuated until we reach FIGS. 7 and 9. At that time this drawing will also aid understanding.

This FIG. 6 also shows a torsion spring 8, located near the base of each worm gear 4. It is stiff enough by design to not coil or uncoil during a contracting shift but is sufficiently giving that it will coil and store energy during an expansive shift.

FIG. 7 generally illustrates an isometric semi-exploded view of a preferred embodiment of one drive of the continuously variable transmission. At its upper left are exterior views of two circuit contacting structures we call platform bodies 10. FIG. 8 generally illustrates a perspective semi-exploded diagrammatic view of a platform body 10 with ratchet racks 15 and 25 and magnets 14 in a preferred embodiment. (Please view FIG. 7 and FIG. 8 together to follow the ensuing discussion of how the platform and its components perform.)

The platform assembly in this embodiment consists of a box, whose top is the platform body 10, with a floor 9, and which contains inside it a sprocket module 11. Except for the magnets 14 and perhaps the sprocket 12, it is made of a non-magnetic material such as aluminum or plastic.

The platform body 10 has a slot 28 in its roof which slot, when the platform is installed in the drive, is oriented tangentially with respect to axis and rotation of the drive, i.e. from near the front to near the back. The platform body's side walls are thick enough to contain vertical bores extending top to bottom: a threaded bore 26 (configured to coact with threads on a worm gear 4 such that said platform bodies move radially relative to the hub and rotational axis of the drive when said worm gear rotates); and a not threaded support rod guide 27 (sized to snugly but slippably receive a support rod 3). These same side walls must not be so tall that the sprocket 12 fails at all times to project through the slot 28, yet be tall enough to allow disengagement of opposing ratchet racks. At the front and rear ends of the platform body 10 are recesses 29 to receive magnets 14. The magnetic poles of the several magnets at one end must be oriented in like direction, so too those at the other end. Extending from side to side through the lower front and rear end walls of the platform body are bores fitted to receive fasteners 13 which project from or through the platform floor 9.

The platform floor 9 has an integral upper face which, relative to the assembled platform body 10, is the lower ratchet rack 25. The lines of the ratchet rack go in what we might consider side to side direction. This upper face of the platform floor contains recesses 29 to receive what we might consider vertically oriented magnets 14. The magnets are installed (with like poles up) deeply enough within the recesses to not physically interfere with notched face of the ratchet rack 25. The platform floor at its front and rear ends also contains front to rear, horizontally oriented recesses 29 to receive magnets 14 (with polarities aligned). Fasteners 13 project from or through the platform floor 9 and join platform body and floor together to form a slotted but otherwise closed box. It may be possible to make either end of the platform floor be front or back with respect to the threaded and unthreaded bores which determine which side of the platform body is which. Because slip vs. engage directionality is critical to the transmission's function (see discussion with respect to FIG. 1), one must think this through and assemble each box with its floor in the one direction correct for it.

Before the box is assembled, a sprocket module 11 is placed within with sprocket 12 projecting through the box's slot 28. The sprocket module consists of a downward facing upper ratchet rack 15, a top surface with a groove 16 into which is welded a sprocket 12 and with recesses 29 facing front, back and down to receive magnets 14. The upper ratchet rack 15 must be oriented to mate with the lower ratchet rack 25. The polarity of every magnet part of the sprocket module in this embodiment is oriented to repel every otherwise located magnet with which it is paired, so that, when the sprocket is not pressed down by the chain, with the help of centrifugal force the module will disengage from the platform floor and migrate to an up-ratchet but intermediate position within the slot.

FIG. 9 generally illustrates a perspective exploded diagrammatic view of the shifting disks 23 and 24 and associated planetary gear assembly 19-23 in a preferred embodiment. At its right, FIG. 7 shows an exterior view of the shifting disks and planetary assembly. (Please view FIG. 6, FIG. 7 and FIG. 9 together in connection with the following discussion of how the shifting disks and planetary assembly perform. Also see FIGS. 3 and 4 for views with calipers 31.)

The bevel gear 21, when the cylindrical stem of it and the hub 1 spin about the drive's axis at different speeds, by its angled faces, turns the pinion gears 6 one way or the other about a radial axis, which turn the worm gears 4 which raise and lower the platforms 10 and sprockets 12. The effective radius of the drive is thereby altered; a shift occurs. How then do we cause the bevel gear 21 and its stem, to rotate around the hub at a different speed than the hub? First, let us establish that the bevel gear and the hub are not rigidly joined together but are part of two different assemblies.

Rigidly attached to the hub 1, at one of the cylinder it forms, is a circular gear plate 17 which houses three planetary gear bearings 20 which in turn house the stems of planet gears 19. This combination of the hub and the gear plate (with planet gear bearings and outwardly toothed planetary gears capable of rotating within the bearings) we will call “the hub assembly.” The hub assembly invariably rotates with the hub 1, just as also does the entire chain supporting structure of the drive—the rods 4 and 7 which radiate from the hub, the pinion gears 6 and platforms 10 and sprocket modules 11 they bear, and the outer rings 5 and 7.

The interior of the stem of the bevel gear 21 is smooth and encircles a portion of the hub, between the threaded rods called worm gears 4 and the gear plate 17. The exterior stem of the bevel gear 21 and the sun gear 22 too are rigidly joined together, and comprise what we will call “the tall shifting disk assembly.” (See FIG. 9 for a view of how these parts come together.) The stem of bevel gear 21 encircles the hub 1 (with angled bevel gears facing upwards away from the hub and inwards toward the platform-bearing rods); the bevel stem fits the hub closely but loosely enough that it may rotate with respect to it. The radially inner edge of the tall shifting disk 23 is welded to the stem of the bevel gear 21, so it invariably rotates as one with the hub 1 when the bevel gear 21 and the hub 1 rotate as one, but it rotates differentially with respect to the hub 1 when the bevel gear 21 speeds up or slows down with respect to the hub 1.

When shifting is not taking place, the tall shifting disk 23 and the angled shifting disk 24 rotate around the drive's axis together with, and at the same number of revolutions per minutes as, the hub 1, the rods 3 and 4, the rings 5 and 7, and the entire drive assembly. These disks, and the three assemblies tend to move together, because the pitch of the threads on the worm gears 4 is so flat that it permits no radially downward force on the platforms 10 to cause turning of the worm gears 4, because the engaged bevel 21 and pinion 6 gears brake any contrary tendency, and because nothing is acting on either shifting disk 23, 24 to make it want to budge.

If, while the hub assembly is rotating, one stops the tall shifting disk 23, one also stops the bevel gear 23 (they are part of the same assembly, welded together); but the pinion gears 6, being part of the hub assembly, move past any given spot on the stationary bevel gear 21. To do so, the pinion gears 6 rotate, thus the worm gears 4 rotate, and the platforms 10 radially ascend or descend in a shift which changes the effective diameter of the drive.

The sun gear 22 too is welded concentrically to the tall shifting disk 23; its teeth point radially outward, like rays from the sun, (so as, when the drive is assembled, to mesh with teeth of the three planetary gears). By virtue of the way they mesh, if the sun gear turns clockwise, the planet gears turn counter-clockwise; and vice versa.

The angled shifting disk 24 is rigidly attached to the circumference gear 18 so that they too turn together as one. Together they comprise what we will call “the angled shifting disk assembly.” The angled shifting disk assembly is neither affixed to nor does it directly contact the hub 1. It relates indirectly to the hub because its component circumference gear has inward facing teeth which mesh with teeth of the three planetary gears 19, and the stems of those planet gears rotate within planet gear bearings 20 which are affixed to (or in) certain positions on the gear plate 17. (The planetary gears and circumference gear are meshed so that if one rotates clockwise, so does the other; and vice versa.) Because the gear plate is part of the hub assembly, when the hub rotates, the gear plate rotates with it, and the stems of the planetary gears come along for the circular ride. If the planetary gears 19 are not rolling each on its own tiny axis (as they do during shifting), the angled shifting disk and its assembly will rotate along with the hub. If the planetary gears 19 are rolling each on its own axis (during shifting), the angled shifting disk and its assembly will rotate around the hub at a speed different from that of the hub assembly.

Due to the interaction of the sun gear 22, the planetary gears 19, and the circumference gear 18, all three must rotate on their own axes if any one of them does. It is also apparent that the sun gear 22 and the circumference gear 18, if both are free to move and one rotates, must rotate in opposite directions, one clockwise, the other counterclockwise. As stated, the circumference gear 18 is part of the angled shift disk 24's assembly, and the sun gear 22 is part of the tall shifting disk 23's assembly. Therefore, if the tall and shifting disks do rotate other than together (as they do when there is no shifting, and both rotate as if they were one the hub), then they must rotate, with respect to one another, in opposite directions.

If, while the hub assembly is rotating, one stops the angled shifting disk 24, this by action of the planetary system will cause the tall shifting disk 23 to speed up in the opposite direction, and cause the bevel gear 23 to turn in the opposite direction with respect to the hub 1; the pinion gears 6, being part of the hub assembly, move past any given spot on the now rotating bevel gear 21. To do so, the pinion gears 6 rotate, thus the worm gears 4 rotate, and the platforms 10 radially descend or ascend in a shift which changes the effective diameter of the drive.

FIG. 10 generally illustrates a two drive chain transmission system including a spring-loaded, frame-mounted mechanism we shall call a chain tensioning arm 33 located between the two drives (left and right, either one could be the input, the other the output). The chain tensioning arm has a chain-carrying end (which may or may not involve a revolving sprocket wheel), a bar with a right-angle bend, and, affixed to the side of the other end of the bar, a cylindrical disk the axis of which is parallel to that of the two drives (and to what might be that of a sprocket wheel on the other end of the bend arm). Through the center of the disk a pin connects the arm to a frame (something the position of which is fixed relative to the two drives. The pin permits rotation of the cylindrical disk. The disk is spring-loaded to return to a neutral position, whereby its chain carrying end takes up any slack in the chain 30, maintaining chain tension at a moderate and approximately constant level. Wrapped around the cylindrical disk in two opposite directions are two cables linked to calipers, one of which is capable of stopping or slowing the tall shifting disk, the other the angled shifting disk, on one of the drives.

On the drive to which the chain tensioning arm is not connected, are calipers to initiate shifting which the operator controls. The chain tensioning arm is designed to initiate a complementary shift of the other drive—to automatically enhance an upshift or a downshift, while keeping the chain, which is of a certain fixed length, under an appropriate amount of tension. If the operator, for example by moving a lever on a bicycle handlebar, tightens a particular caliper 31 on the right hand drive, and this causes the right hand drive to contract, the chain will at least momentarily go slack. In response to the pressure of springs which attach to the frame and the cylindrical disk of the chain tensioning arm, the cylinder will rotate and the chain tensioning arm's 33 chain-bearing end will push against the chain restoring the desired amount of tension to the chain. In the process of its rotation, the cylinder will wind up and pull one cable, and unwind the other. Whichever shifting disk will cause the second drive to expand is the one to which attaches the cable which the cylinder pulls on when a contracting shift of the first drive causes said cylinder's rotation.

Similarly if the operator causes an expanding shift of the first drive, the tightening chain will move against and push the chain-bearing end of the chain tensioning arm, overcoming resistance of the arm's springs. The cylinder will turn in the opposite direction, the cable to get pulled will be the other one, and the second drive will contract.

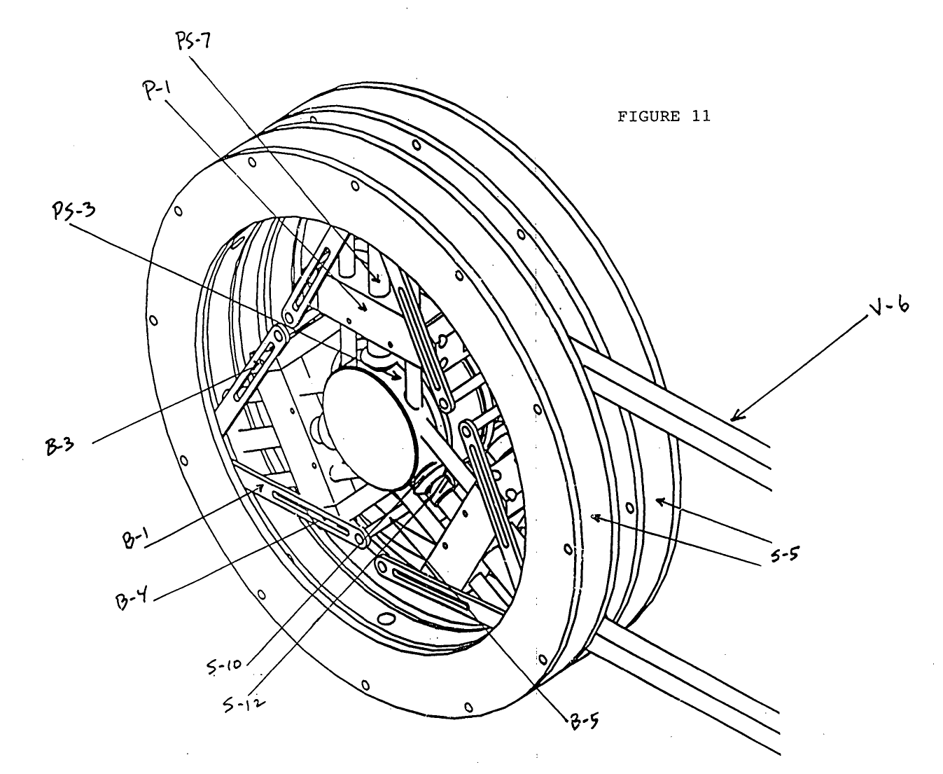

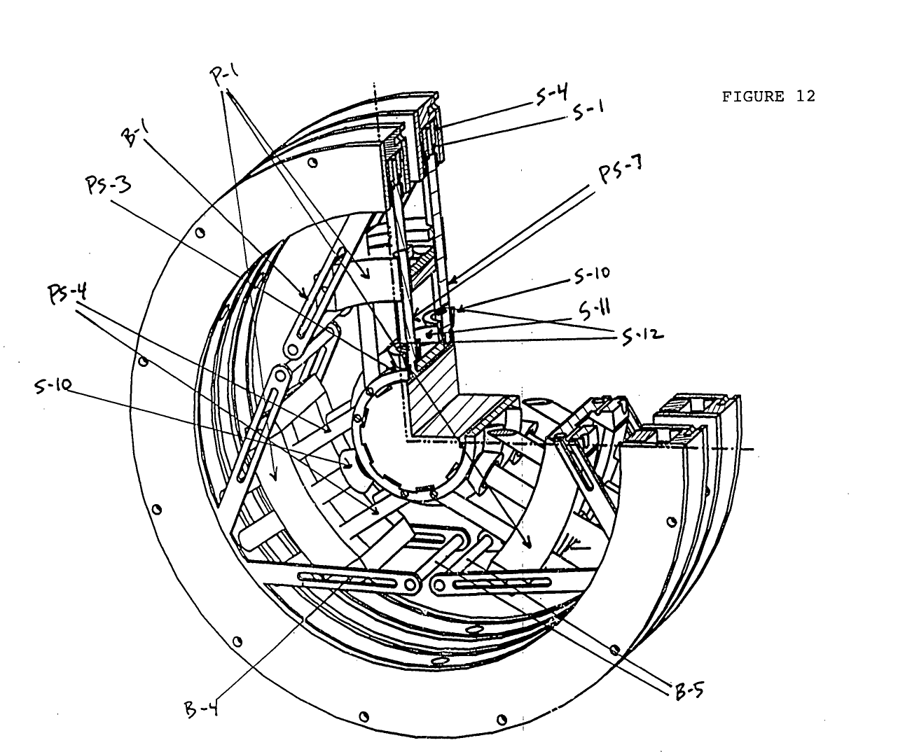

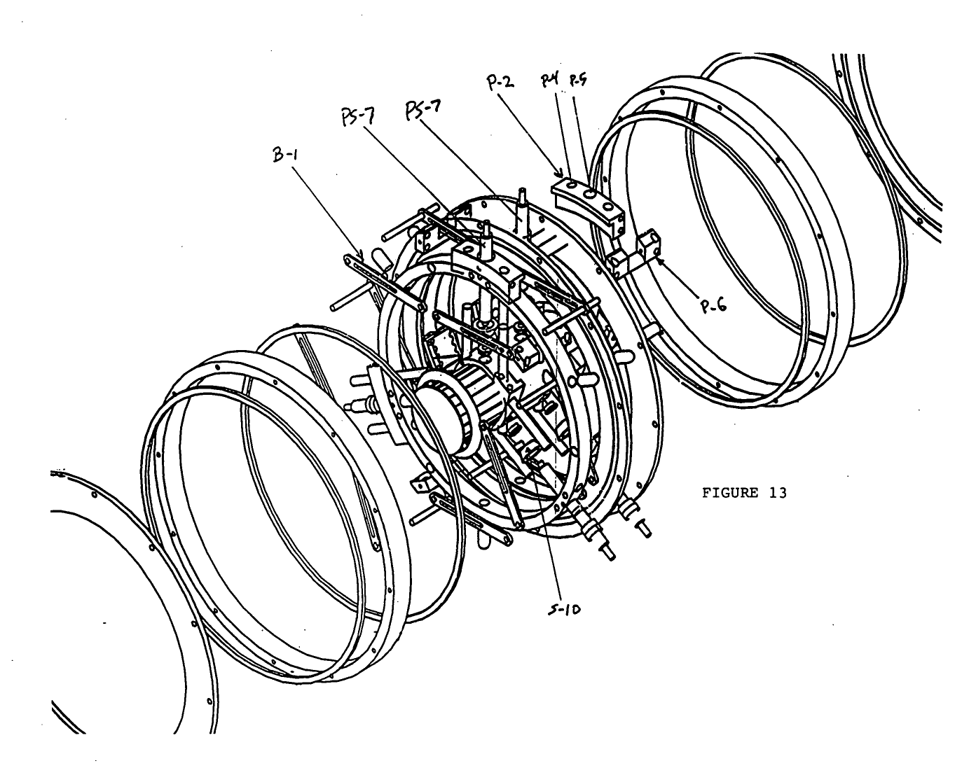

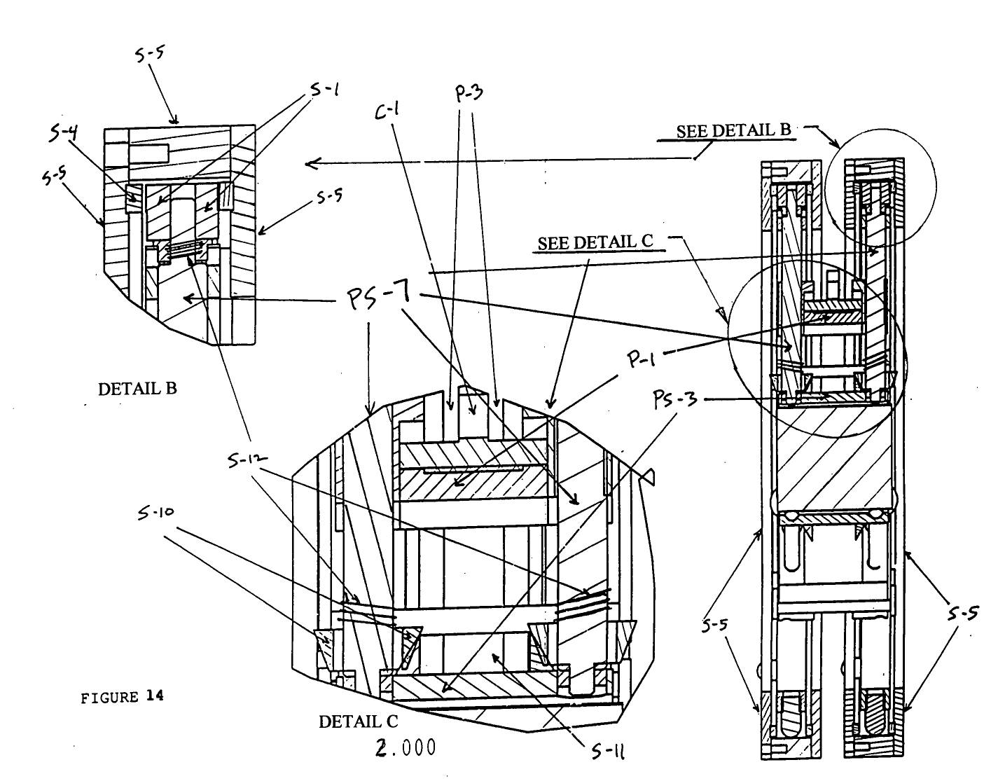

FIGS. 11, 12 and 13 show different views, in a similar isometric perspective, of the same sturdy embodiment of a single variable radius drive, as might be located on either a drive shaft or a driven shaft of a bicycle or motor. FIG. 14 is a cross-sectional end view of the same drive, with enlarged details. FIG. 11 generally illustrates an isometric view of a sturdy embodiment. FIG. 12 is partially cut away to reveal inner detail. FIG. 13 is exploded for better identification of certain parts. In the following discussion we explain how by their turning the threaded rods PS-7 determine and vary the effective radius of the drive by establishing the height of platforms P-1 and other chain bridging means B-1 relative to the support hub PS-3 and support rings PS-5, also how turning of the threaded rods PS-7 is actuated and coordinated by the shifting disks S-5.

As shown in FIGS. 11-14, platforms P-1 are shown positioned at a position intermediate between their highest and lowest positions relative to the support hub PS-3. Three platforms are shown in this particular embodiment; two is a minimum; more than three might be desired. The support hub PS-3 is co-axial and rigidly affixed to the axle PS-1. In FIG. 11 a chain V-6 is shown emerging from between the two shifting disks S-5. The shifting disks function to initiate and coordinate shifting. Each shifting disk S-5 rests on a support ring PS-5. One is to the left of the chain, one to the right. The support rings function to carry in radially variable fashion the platforms (and as elsewhere discussed the sprocket teeth C-1 which move within channels P-3 mounted thereon). Each support ring PS-5 is joined to the central support hub PS-3 by columns PS-4 and threaded rods PS-7. In this embodiment each platform by threaded bores P-5 receives two threaded rods PS-7, one to the left of the chain, one to the right; and each platform, in support column guides P-4, takes four columns PS-4, two the left of the chain, two to the right. One threaded rod per platform is part of a particular support ring structure and is threaded clockwise, the other is part of the other support ring and is threaded counterclockwise. Each platform contains a pair of threaded bores PS-5, one threaded clockwise, the other counterclockwise, to receive the two threaded rods PS-7 so that the platform is radially raised or lowered by turning of the threaded rods. Each platform likewise contains support column guides P-4, of which there are four per platform in this embodiment which embrace columns PS-4, so that the columns and guides together stabilize the platforms and prevent them from twisting, allowing them instead to move up or down, when the threaded rods turn.

This is a sturdy embodiment of the invention and for good reason. If the platforms are not only to support the chain (or belt) but also to support means for dynamic repositioning of the sprocket segment (or other chain or belt attachment device), a great deal of stability is needed.

The distance of the platforms from the hub is varied by coordinated rotation of the threaded rods. As best seen in FIGS. 12 and 14, during rotation of the drive, coordinated turning of each threaded rod to one side of the chain is initiated, via a spur gear S-1 affixed at the top of each threaded rod, when one of the shifting disks S-5, which bears a 360 degree spur gear rack S-4 to which the spur gear S-1 is engaged, is immobilized relative to the revolving hub PS-3 and support ring PS-5. The one shifting disk thus slows or stops, and the threaded rod associated by spur gear with the immobilized shifting disk receives a spin. Support columns PS-4 prevent each platform P-1 from spinning along with the threaded rod PS-7; they constrain it instead to travel up or down the threaded rod.

In this embodiment where the platform is supported from both left and right of the chain, it is not enough that the threaded rod to one side of the chain spin; that on the other side must spin as well (and in reverse direction, in this embodiment, as its threading is reversed). To turn the threaded rods to the other side of the chain, a double faced bevel transfer gear S-11 which embraces and can revolve about the support hub PS-3 translates the turning of threaded rods PS-7 of one side to the other via pinion gears S-10 affixed at the foot of each threaded rod. Thus the two threaded rods per platform in coordination with one another cause a platform's coordinated radial movement up or down from the hub, increasing or decreasing the drive's effective radius. In a related development, the shifting disk S-5 which is not immobilized is caused to rotate at extra speed.

FIGS. 12 and 14 show a bicycle embodiment with coil springs S-12 to defer expansive shifting under the chain's load but to shift without delay while the platform is free of the chain or in contracting shift mode. Each such coil spring is attached at one end to the worm gear PS-7 near its top, spur gear S-1, end or its bottom, pinion gear S-10, end. The coil spring S-12's other end is attached to the spur gear S-1 or to the pinion gear S-10, as the case may be. Thus the pinion gears S-10, connected as they are to a common transfer gear S-1, will turn in concert. So too will the spur gears S-1, connected as they are to a common spur gear rack S-4. But if the compressive force of the chain is strong enough, a platform P-1 under chain will not lift nor will its worm gear PS-7 turn; instead, the springs S-12 will uncoil—to recoil upon release by the chain a short while later and lift the platform as it rotates into “free” position. (Those platforms initially free will already have been lifted.) The coil spring is strong enough that it neither coils nor uncoils, and the worm gear turns as if rigidly joined, during a contracting shift and during non-shifting operation. (In another likely better preferred bicycle embodiment which defers to expansive shifting chain pressure in much the same manner, coil springs S-12 are found only at the bottom of each worm gear PS-7, shifting is actuated and coordinated only toward the bottom of the worm gears PS-7, and there are no spur gears S-1, spur gear racks S-4, or shifting disks S-5.)

To bridge between platforms and thus improve the drive's circularity, FIGS. 11, 12 and 13 show chain-support bars B-5, each of which is supported to the left and to the right of the chain by a cantilevered support arm B-1. The support arms thus come in pairs, two per chain-support bar. The chain-support bars do not grip the chain but merely push the chain radially out from the hub so that it better approximates a circle as it travels over the drive. Each support arm is attached by a pin B-2 in pivoting fashion at its fixed end to a support ring PS-5. Another pin B-4 fixed toward the end of the platform's side wall P-2's exterior surface passes through a slot B-3 running through a middle part of the support arm toward its support bar terminus. As the platforms P-1 (bearing sprocket segments C-1) rise or lower on the threaded radial rods PS-7, the platform-mounted pins B-4 slide within the slots B-3 of the support arms B-1 and the chain bar support members B-5 correspondingly rise or lower radially with respect to the hub PS-3. Pins B-2 and B-4 are positioned so that, regardless of platform height, each chain support bar supports the chain at a height (i.e. radius from hub) approximately equal to that of each platform mounted sprocket segment.

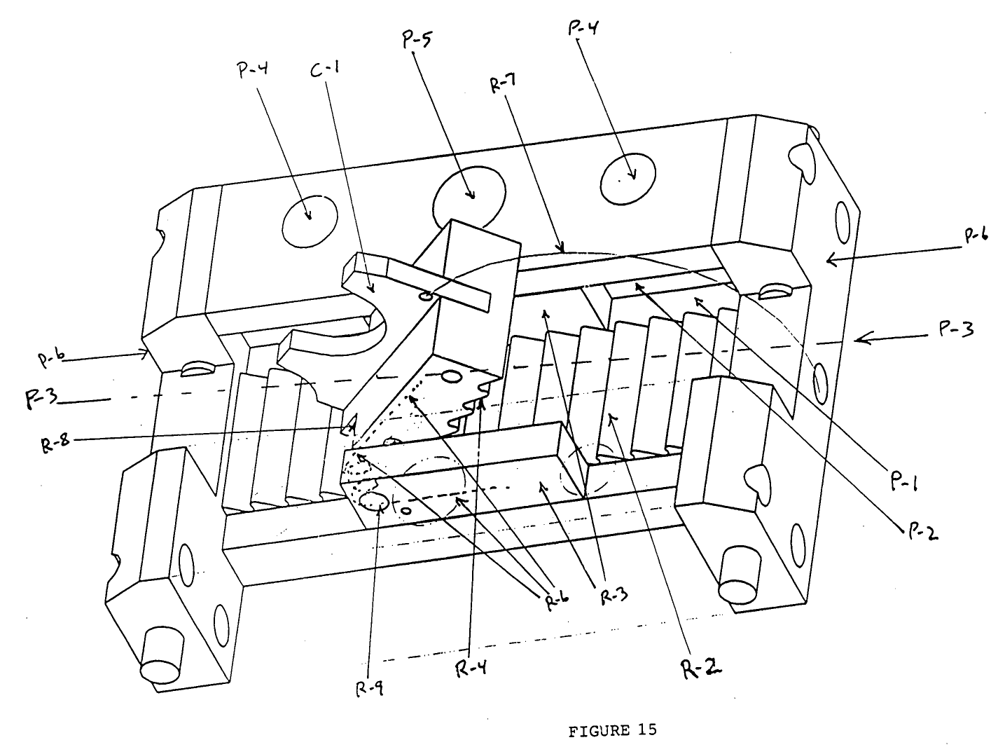

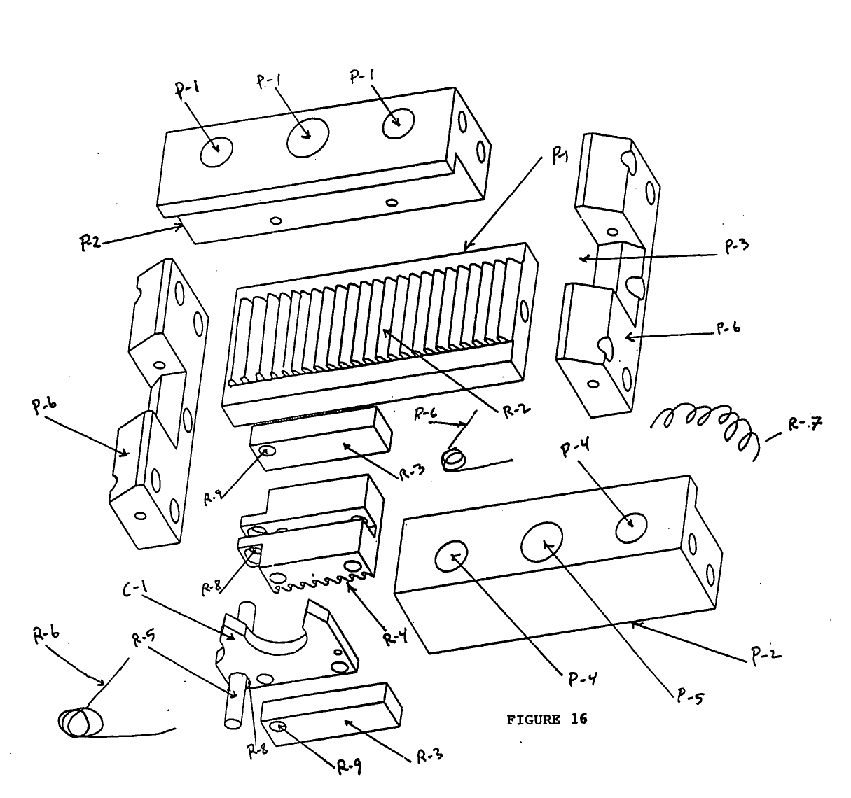

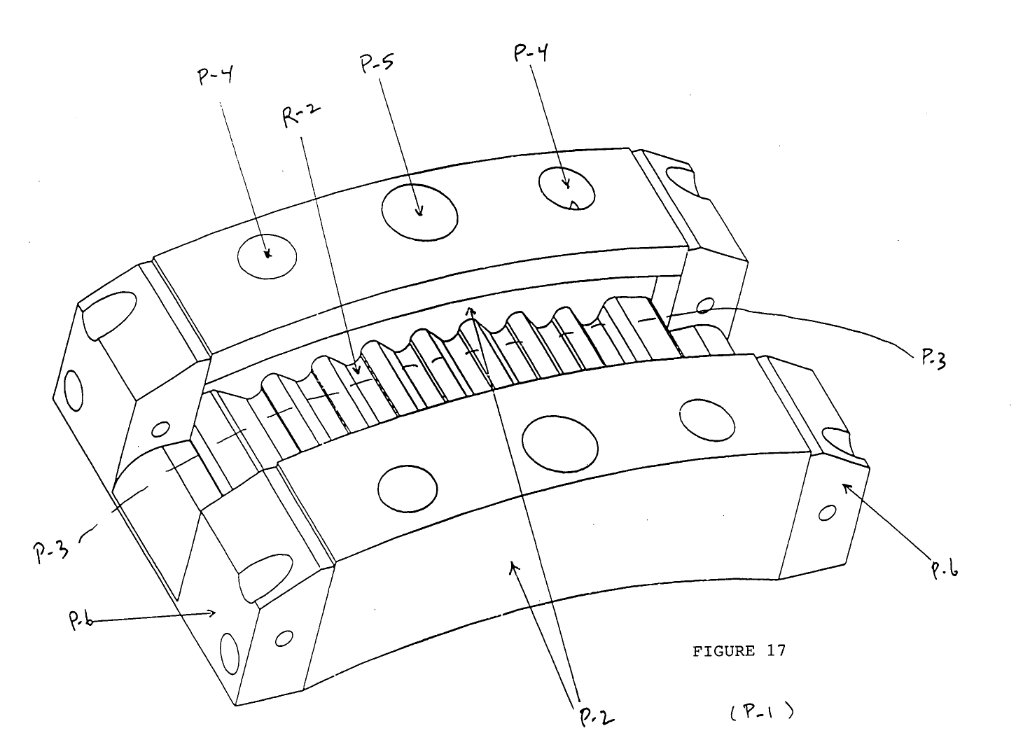

FIG. 15 presents a perspective view from above of a preferred bicycle embodiment's platform assembly P-0, with a sprocket segment C-1 carried on an upper platform base R-3 capable of forward and backward motion within a channel P-3 of said platform assembly. If the ratchet racks by their shape are likened to waves breaking against a “shore,” the upper ratchet rack in this FIG. 15 view is hinged through an elliptical hinge hole R-8 at its “shoreward” end, and it is for use on an output drive, or rear cog. (The upper ratchet rack would be hinged at its “seaward” end if for use on an input drive, or chainring; otherwise the platform need show no differences.) The sprocket segment in this Figure is shown unloaded by the chain, so that a hinge spring R-6 causes it to tilt up. The near sidewall of the platform base is missing to reveal details. FIG. 16 gives an exploded perspective view of a platform including an upper ratchet rack. FIG. 17 shows an alternative platform base constructed on a radius.

The channel P-3 in FIGS. 15 through 17 is formed by a platform base P-1, two grooved side walls P-3, and two end plates P-6. An upper ratchet rack R-4 is hinge-mounted on springs R-6 to the upper platform base sides R-3 and hinge pin R-5 over a lower ratchet rack R-2 on the platform base P-1 within the channel P-3. When the sprocket segment C-1 is not under pressure of the chain, hinge springs R-6 cause the upper-ratchet rack R-4 to lift within the elliptical hinge hole R-8 and to tilt up so that the upper and lower ratchet racks disengage, and coil springs R-7 return the upper platform base R-3, if it has moved from there, to a position of beginning, “seaward” within the channel R-3.

In the following discussion we explain at the platform level how the invention works to facilitate proper chain engagement, how it engages positively to transmit power, how it releases during shifting to permit dynamic repositioning of the sprocket segment under pressure of the chain, and how, once released of the chain, the upper ratchet rack and sprocket segment return to a suitable place from which to again engage the chain.

As stated above, chain mis-engagement has been a downfall of variable radius chain transmissions in the prior art. To ensure proper engagement of the chain regardless of radius and thus solve the misalignment problem, the present invention offers six features: (1) movability of the sprocket segment within a channel; (2) springs; (3) sprocket-chain approach angle; (4) vertical play within the upper platform hinge; (5) pointed sprocket teeth; and (6) unloaded engagement.

The sprocket segment C-1 and upper platform base R-3, R-5, R-3 are mounted to the platform base P-1 and effective circumference of the drive not rigidly but movably within a channel P-3. Thus the sprocket segment can dynamically reposition itself forward or back before seating.

To enable such forward and back movement in the depicted embodiment, one set of springs R-6 holds the upper ratchet gear rack R-4 and lower ratchet gear rack R-2 apart from one another when they are not being pressed together by the compressive force of the chain. Another spring R-7 biases the position of the upper platform base R-3 toward the “seaward” end of the platform P-1 to facilitate its return, in case it has been relocated by shifting, to a good place of beginning.

Approach angle also helps chain joints and sprocket teeth to successfully engage. The FIG. 15 type platform travels with its hinge trailing. Thus, when it is free of the chain, its sprocket inclines toward the chain where it will next engage, leading the way in a tilted open position to meet the chain. Such a tilted approach angle facilitates means the chain and sprocket approach one another at a less glancing angle and more readily engage, particularly with aid of the other engagement-furthering features. The spring-tilt also facilitates disengagement of chain and sprocket tooth from one another without the tearing this process normally entails as they separate unloaded by the chain and with their faces “falling away,” nearly parallel one another.

As shown in FIG. 15, a circular hinge pin R-7 connects the two sides of the upper platform base R-3. This pin passes through a vertically elongated elliptical hole in the hinged end of the upper ratchet rack gear R-4 and sprocket segment C-1. The vertical play this allows, important primarily to the ratcheting process during shifting, also aids the prospects of successful chain engagement.

To further reduce the chance of chain mis-engagement, the sprocket teeth C-1 (as shown) and chain joints (see Green and Palley U.S. Pat. No. 5,520,585 and U.S. Pat. No. 5,728,023) can be pointed or otherwise shaped to facilitate meshing. With a normal roller chain and sprocket, this would interfere with chain engagement and disengagement, but it is permitted in this trailing spring-hinged embodiment.

That each sprocket segment receives and gives up the chain or belt while not under full load also reduces the probability and the consequences of potential chain mis-engagement. In addition, it minimizes wear and friction, increasing efficiency of the transmission.

When mated and seated, the upper and lower ratchet racks of this embodiment of the invention (R-4 and R-2) engage positively to transmit power. Ample surface area of the one rack is in direct opposition and contact with ample surface area of the other. The chain presses them together. No incline or angle of contact facilitates their separation when they are forced against one another in what we have elsewhere termed “normal work direction.” Power can be transmitted positively and quite effectively with this invention; it permits an expanded number of effective gear ratios since the distance between adjacent seating positions for a given sprocket segment can be considerably shorter than one chain link. More gears makes it possible to better optimize gear choice. Also, finding the right gear from those available is easy since all gears are sequentially arranged. This makes shifting uncomplicated and also permits automatic shifting based on crank speed, heart rate, or other measured operating or operator parameters.

Dynamic repositioning during shifting occurs in this preferred bicycle embodiment of the invention when mated ratchet racks on a single platform slip with respect to one another in the permitted direction. Sprocket segment C-1, drawn by spring R-7 toward the “seaward” end of the platform, i.e. the right hand side as shown in FIG. 15, is pressed down by the chain so that upper ratchet rack R-4 is flattened against, and meshes with the lower ratchet rack R-2. Initial seating of the sprocket segment on the platform will occur toward this seaward end of the platform, no more than half a chain length, i.e. one to three ratchets, one way or the other, from the poised point of beginning. Next arises the need for dynamic repositioning of the sprocket segment relative to platform as explained with reference to the preferred embodiment in FIG. 1: either the platforms rise in an expanding shift or descend in a contracting shift; in either event, chain tension pulls the sprocket segment of this or another similar neighboring platform (provided it is not the one required to hold fast and bear workload of the chain) “shoreward” (to the left, as shown in FIG. 15).

For ratcheting to occur under pressure of the chain, the pitch of the ratchet racks, R-2 and R-4, must not be too steep. Thirty degrees as shown in FIG. 15 is good. The pitch shown in FIGS. 16 and 17 may be too steep. The ninety or so degree angle of the ratchet rack's other pitch prevents relative movement under chain in the unintended direction. The elliptical hinge hole R-8 is a means in this embodiment for allowing adequate separation for ratcheting of the upper and lower ratchet racks.

Having ratcheted shoreward to accommodate shifting, the upper ratchet rack and sprocket segment, when able, must return to a suitable place from which to again engage the chain. The two sets of springs accomplish this. Once the sprocket segment C-1 is released of the chain, the hinge spring R-6 separates the upper and lower ratchet racks, R-4 and R-2. Spring R-7 then is able to pull the entire upper platform assembly, R-3 et seq, “seaward,” back to a place near the seaward end of the lower ratchet rack R-2.

1- A continuously variable transmission for a drive train, the continuously variable transmission comprising in combination:
an elongate flexible element in the form of a circuit;
at least two rotating supports having separate rotational axes spaced from each other and each located inside said circuit with said rotating supports contacting said circuit;
at least one of said rotating supports having at least two circuit contacting structures adapted to contact said circuit and transmit force between said circuit and said rigid support to which said contacting structures are connected;
said circuit contacting structures adapted to move radially relative to said axis of said rotating support, such that a functional diameter of said rotating support is modified; and
said circuit contacting structures adapted to move laterally in a non-radial and non-parallel-to-axis direction relative to other portions of said rotating support.

2- The continuously variable transmission of claim 1 wherein said circuit is a chain of multiple separate substantially rigid links pivotably connected to each other.

3- The continuously variable transmission of claim 1 wherein said circuit includes a belt of flexible material.

4- The continuously variable transmission of claim 1 wherein said circuit contacting structure includes a transverse V-shaped groove with the point of the V directed toward the axis.

5- The continuously variable transmission of claim 1 wherein said circuit contacting structure includes a groove fitted to receive a cog belt.

6- The continuously variable transmission of claim 1 wherein the lateral, non-radial and not parallel to axis direction in which said circuit contacting structure is adapted to move is tangential to the rotation of said rotating support.

7- The continuously variable transmission of claim 1 wherein the lateral, non-radial and not parallel to axis direction in which said circuit contacting structure is adapted to move is circumferential to the rotation of said rotating support.

8- The continuously variable transmission of claim 1 wherein said at least some of circuit contacting structures include a sprocket segment with at least one sprocket tooth extending from said sprocket segment in a direction away from said rotational axis of said rotating support to which said sprocket segment is coupled.

9- The continuously variable transmission of claim 8 wherein said circuit which is a chain of multiple separate substantially rigid links pivotably connected to each other and said sprocket tooth is pre-positioned to mate with the links of said chain by at least one spring.

10- The continuously variable transmission of claim 8 wherein said circuit which is a chain of multiple separate substantially rigid links pivotably connected to each other and said sprocket tooth is pre-positioned to mate with the links of said chain by at least one magnet.

11- The continuously variable transmission of claim 8 wherein said circuit which is a chain of multiple separate substantially rigid links pivotably connected to each other and said sprocket tooth is mechanically pre-positioned to mate with the links of said chain.

12- The continuously variable transmission of claim 8 wherein at least one of said rotating supports includes at least two circuit contacting structures in the form of at least two separate sprocket segments.

13- The continuously variable transmission of claim 8 wherein at least one of said rotating supports includes at least six circuit contacting structures in the form of at least six separate sprocket segments.

14- The continuously variable transmission of claim 1 wherein a worm gear is provided between said rotational axis of at least one of said rotating supports and said circuit contacting structure of at least one of said rotating supports, said worm gear adapted to rotate about an axis extending radially away from said rotational axis of said rotating support, said circuit contacting structure coupled to threads configured to coact with threads on said worm gear such that said circuit contacting structure moves radially relative to said rotational axis of said rotating support when said worm gear rotates.

15- The continuously variable transmission of claim 14 wherein a spring is provided between said rotating support and said worm gear such that said radial movement of said circuit contacting structure relative to said rotational axis may be deferred to a time when said circuit contacting structure is at least relatively free of said circuit.

16- The continuously variable transmission of claim 14 wherein, to more closely approximate a true circular path for the circuit to follow around at least one of said rotating supports, between at least two of said circuit contacting structures coupled to threads coacting with said worm gears, there is positioned at least one additional circuit contacting structure.

17- The continuously variable transmission of claim 16 wherein the additional circuit contacting structure comprises at least one cantilevered support arm.

18- The continuously variable transmission of claim 16 wherein the additional circuit contacting structure comprises at least one leaf spring, configured, in case there be more than one, to overlap and lend strength to one another.

19- The continuously variable transmission of claim 16 wherein the additional circuit contacting structure comprises at least one V-shaped segment extending tangentially from at least one of said circuit contacting structures coupled to threads.

20- The continuously variable transmission of claim 1 wherein said circuit contacting structure is coupled to said rotating support through a pair of complemental ratchet racks including an upper ratchet rack and a lower ratchet rack, each said ratchet rack including teeth thereon complemental to each other, such that said teeth of said upper rack can mesh with said teeth of said lower rack at multiple different relative positions with said upper rack spaced laterally relative to a radial centerline passing through said rotational axis of said rotating support and through a center of said lower ratchet rack, such that said upper rack can be securely engaged with said lower rack at various different tangentially displaced positions, said circuit contacting structure coupled to said lower rack through said upper rack.

21- The continuously variable transmission of claim 1 wherein said circuit contacting structure is coupled to said rotating support through a pair of complemental ratchet racks including a upper ratchet rack and a lower ratchet rack, each said ratchet rack including teeth thereon complemental to each other, such that said teeth of said upper rack can mesh with said teeth of said lower rack at multiple different relative positions with said upper rack spaced laterally relative to a radial centerline passing through said rotational axis of said rotating support and through a center of said lower ratchet rack, such that said upper rack can be securely engaged with said lower rack at various different circumferentially displaced positions, said circuit contacting structure coupled to said lower rack through said upper rack.

22- The continuously variable transmission of claim 20 wherein said upper ratchet rack when not meshed with said lower ratchet rack under the compressive force of said circuit is suspended radially beyond said lower ratchet rack and is positioned by at least one magnet in readiness to be meshed by the compressive force of said circuit.

23- The continuously variable transmission of claim 20 wherein said upper ratchet rack when not meshed with said lower ratchet rack is suspended radially beyond it and positioned by at least one spring.

24- The continuously variable transmission of claim 20 wherein said circuit is a chain having multiple rigid links pivotably coupled together with each said link having a substantially similar length; and
wherein a spacing between teeth in said upper ratchet rack and said lower ratchet rack is less than a spacing between said links in said chain forming said circuit.

25- The continuously variable transmission of claim 24 wherein said teeth have a spacing which is less than one-tenth of a length of said chain links within said chain forming said circuit.

26- The continuously variable transmission of claim 21 wherein said upper ratchet rack when not meshed with said lower ratchet rack is suspended radially beyond it and positioned by at least one spring.

27- A power transmission for a drive train, comprising in combination:
an elongate flexible element in the form of a circuit;
at least two rotating supports including a driver coupled to a power input and a follower coupled to a power output, each said rotating support having a separate rotational axis located inside said circuit, each said rotating support contacting said circuit;
each said rotating support adapted to contact said circuit while exhibiting a plurality of different functional diameters, such that an effective gear ratio between the power input at the driver and the power output at the follower can be modified;
means for controlling a functional diameter of said driver;
means for controlling a functional diameter of said follower;
at least one of said functional diameter controlling means adapted to automatically adjust the functional diameter of a first one of said rotating supports when a second one of said rotating supports has its functional diameter modified, said automatic adjustment occurring in a manner needed to maintain substantially constant a length of a path for said circuit around said driver and said follower, such that tension on a substantially inelastic circuit remains constant as the functional diameters of the rotating supports undergoes change.

28- The transmission of claim 27 wherein said driver includes at least one circuit contacting structure adapted to contact said circuit and transmit force between said circuit and said follower; and
said circuit contacting structure adapted to move radially relative to said axis of said follower, such that a functional diameter of said follower is modified.

29- The transmission of claim 27 wherein said follower includes at least one circuit contacting structure adapted to contact said circuit and transmit force between said circuit and said follower; and
said circuit contacting structure adapted to move radially relative to said axis of said follower, such that a functional diameter of said follower is modified.

30- The transmission of claim 27 wherein said circuit is a chain and said driver includes a plurality of separate sprockets attached to said driver and laterally spaced from each other along with a derailleur for moving the chain between separate sprockets, and a derailleur position control means coupled to said derailleur.

31- The transmission of claim 27 wherein said follower includes a plurality of separate sprockets attached to said follower and laterally spaced from each other along with a derailleur for moving the chain between separate sprockets, and a derailleur position control means coupled to said derailleur.

32- The transmission of claim 27 wherein one of said at least two rotating supports has a functional diameter thereof controlled by an external input and the other of said rotating supports has a functional diameter controlled based on the functional diameter of the other of said rotating supports with the functional diameter of the other of the rotating supports controlled to maintain a constant length path for said circuit and a constant tension for said circuit about said at least two rotating supports.

33- A continuously variable transmission for a drive train, the continuously variable transmission comprising in combination:
an elongate flexible element in the form of a circuit;
at least two rotating supports having separate rotational axes spaced from each other and each located inside said circuit with said rotating supports contacting said circuit;
at least one of said rotating supports having at least two circuit contacting structures adapted to contact said circuit and transmit force between said circuit and said rigid support to which said contacting structures are connected;
said circuit contacting structures adapted to move radially relative to said axis of said rotating support by means of a worm gear provided between said rotational axis of at least one of said rotating supports and said circuit contacting structure of at least one of said rotating supports, said worm gear adapted to rotate about an axis extending radially away from said rotational axis of said rotating support, said circuit contacting structure coupled to threads configured to coact with threads on said worm gear such that said circuit contacting structure moves radially relative to said rotational axis of said rotating support when said worm gear rotates, such that a functional diameter of said rotating support is modified; and
wherein a spring is provided between said rotating support and said worm gear such that said radial movement of said circuit contacting structure relative to said rotational axis may be deferred to a time when said circuit contacting structure is at least relatively free of said circuit.

34- The transmission of claim 23 wherein, to more closely approximate a true circular path for the circuit to follow around at least one of said rotating supports, between at least two of said circuit contacting structures coupled to threads coacting with said worm gears, there is positioned at least one additional circuit contacting structure.
